(19) United States
(12) Patent Application Publication
(10) Pub. No.: US 2015/0193342 A1
(43) Pub. Date: Jul. 9, 2015

(54) STORAGE APPARATUS AND METHOD OF CONTROLLING THE SAME

(71) Applicant: Hitachi, Ltd., Tokyo (JP)

(72) Inventors: Mao Ohara, Odawara-shi (JP); Saeko Yoshida, Odawara-shi (JP); Takaki Matsushita, Nishi-ku (JP)

(73) Assignee: HITACHI, LTD., Tokyo (JP)

(21) Appl. No.: 13/640,136

(22) PCT Filed: Sep. 25, 2012
(86) PCT No.: PCT/JP2012/006098

§ 371 Date: Oct. 9, 2012

(51) Int. Cl. G06F 12/08

(52) U.S. Cl. CPC G06F 12/0802; G06F 2212/1016; G06F 2212/401; G06F 2212/604

(57) ABSTRACT

Provided is a storage apparatus to provide a data storage area to an external apparatus. The storage apparatus includes a storage drive to provide a physical storage area for the data storage area; and a storage control unit to manage the data storage area as an un-compression storage area that is a logical storage area for storing data in the external apparatus in an uncompressed form and as a compression storage area that is a logical storage area for storing data in the external apparatus in a compressed form, and to control each of data write processing and data read processing on the storage drive according to a data input-output request from the external apparatus. The compression storage area and the un-compression storage area each include a set of unit physical storage areas formed by dividing the physical storage area. The storage control unit includes an un-compression cache area that is a temporary memory area for storing un-compressed data, a compression cache area that is a temporary memory area for storing compressed data, and a read cache area that is a temporary memory area for storing data read from the compression storage area. When reading data from the compression storage area in response to a data read request from the external apparatus, the storage control unit decompresses the read data and stores the decompressed data to the read cache area. In a case where the storage control unit receives a data read request from the external apparatus and where read target data of the data read request is stored in the compression storage area, the storage control unit judges whether or not the read target data is stored in the read cache area. When judging that the data is stored in the read cache area, the storage control unit transfers the data stored in the read cache area to the external apparatus. When judging that the data is not stored in the read cache area, the storage control unit reads the read target data from the compression storage area, decompresses the data, and then transfers the decompressed data to the external apparatus.

### TECHNICAL FIELD

The present invention relates to a storage apparatus and a method of controlling a storage apparatus.

### BACKGROUND ART

In general, a storage apparatus is communicatively coupled to a host computer (hereinafter referred to as a “host”) such as a server computer configured to execute data processing, and is used as a storage area for data to be processed by the host. In recent years, with drastic increase in the volume of data stored in a storage apparatus, various techniques have been proposed for storing data in the storage apparatus as efficiently as possible. These techniques include a thin provisioning technique, a data compression technique, and the like. In the thin provisioning technique, the storage resources of a storage apparatus allocated to a host are dynamically varied in size depending on the required data sizes. The data compression technique is for reducing the data size of data to be stored.

The thin provisioning technique is a technique of enabling more efficient utilization of a storage device in such a way that a certain size of storage capacity is reserved in advance as a storage area for storing data from a host, and that an actual physical storage area is allocated in association with a unit logical storage area having a small storage capacity as needed for data storage. The data compression technique is a technique of reducing the size of data to be stored in a storage apparatus by using appropriate data compression algorithm.

For example, PTL 1 discloses that a physical storage area in a size suitable to the data size compressed by data compression is allocated to each of the virtual pages that are unit logical storage areas allocated to a logical storage area created by thin provisioning. In addition, PTL 2 discloses that when data write processing onto a compression logical storage area is received from a host, new data is created by merging the write data with old data decompressed after being read from the compression logical storage area, and then the created new data is compressed and stored in the compression logical storage area in post processing.

### CITATION LIST

### Patent Literature

PTL 1: United States Patent Application Laid-open Publication No. 2009/0144496

PTL 2: International Publication No. 2010/086900 pamphlet

### SUMMARY OF INVENTION

### Technical Problem

Neither PTL 1 nor PTL 2, however, discloses which area in a cache memory to use to store decompressed data when read processing from a compression logical storage area occurs. In one possible configuration, decompressed read data is stored in an area in the cache memory allocated to an un-compression unit logical storage area where to store uncompressed data. In this configuration, every time the read processing is performed, data read to the cache memory needs to be read to the un-compression unit logical storage area and then be compressed again. Hence, with an increase in tasks of the read processing, the storage apparatus has a problem that a sufficient performance of the apparatus as a whole cannot be ensured.

### Solution to Problem

In order to solve the foregoing and other problems, an aspect of the present invention provides a storage apparatus configured to provide a data storage area to an external apparatus, including a storage drive configured to provide a physical storage area for the data storage area; and a storage control unit configured to manage the data storage area as an un-compression storage area that is a logical storage area for storing data in the external apparatus in an uncompressed form and as a compression storage area that is a logical storage area for storing data in the external apparatus in a compressed form, and to control each of data write processing and data read processing on the storage drive according to a data input-output request from the external apparatus, wherein the compression storage area and the un-compression storage area each include a set of unit physical storage areas formed by dividing the physical storage area, the storage control unit includes an un-compression cache area that is a temporary memory area for storing uncompressed data, a compression cache area that is a temporary memory area for storing compressed data, and a read cache area that is a temporary memory area for storing data read from the compression storage area, when reading data from the compression storage area in response to a data read request from the external apparatus, the storage control unit decompresses the read data and stores the decompressed data to the read cache area, in a case where the storage control unit receives a data read request from the external apparatus and where read target data of the data read request is stored in the compression storage area, the storage control unit judges whether or not the read target data is stored in the read cache area, when judging that the data is stored in the read cache area, the storage control unit transfers the data stored in the read cache area to the external apparatus, and when judging that the data is not stored in the read cache area, the storage control unit reads the read target data from the compression storage area, decompresses the data, and then transfers the decompressed data to the external apparatus.

### Advantageous Effects of Invention

According to the present invention, provided are a storage apparatus and a method of controlling a storage apparatus that enable more efficient utilization of storage resources of the storage apparatus while appropriately maintaining the performance of the storage apparatus.

### BRIEF DESCRIPTION OF DRAWINGS

FIG. 1 is a diagram schematically illustrating a configuration example of a storage system 1 according to an embodiment of the present invention.

FIG. 2 is a diagram illustrating a software configuration example of a storage control unit 1100A (1100B) in a storage apparatus 100.

FIG. 3 is an explanatory diagram of chunks formed from a thin provisioning pool.

FIG. 4 is a diagram illustrating a mapping between logical storage areas for storing data and chunks in a thin provisioning pool.

FIG. 5 is a diagram illustrating a configuration example of a mapping table 1400.

FIG. 6 is a diagram illustrating an outline of data processing executed by the storage system 1.

FIG. 7A is a diagram illustrating a flow example of initial compression processing on a virtual LU.

FIG. 7B is a diagram illustrating an outline of the initial compression processing on a virtual LU.

FIG. 7C is a diagram illustrating a change in data size by data compression processing in this embodiment.

FIG. 8A is a diagram illustrating a flow example of initial compression processing on a normal LU.

FIG. 8B is a diagram illustrating an outline of the initial compression processing on a normal LU.

FIG. 9A is a diagram illustrating a flow example of read processing from a virtual LU during compression.

FIG. 9B is a diagram illustrating an outline of the read processing from a virtual LU during compression.

FIG. 10A is a diagram illustrating a flow example of write processing to a virtual LU during compression.

FIG. 10B is a diagram illustrating an outline of the write processing to a virtual LU during compression.

FIG. 11A is a diagram illustrating a flow example of write processing to a normal LU during compression.

FIG. 11B is a diagram illustrating an outline of the write processing to a normal LU during compression.

FIG. 12A is a diagram illustrating a flow example of read processing from a compression LU.

FIG. 12B is a diagram illustrating an outline of the read processing from a compression LU.

FIG. 13A is a diagram illustrating a flow example of write processing to a compression LU.

FIG. 13B is a diagram illustrating an outline of the write processing to a compression LU.

FIG. 14A is a diagram illustrating a flow example of background compression processing.

FIG. 14B is a diagram illustrating an outline of the background compression processing.

### DESCRIPTION OF EMBODIMENTS

Hereinafter, embodiments for carrying out the invention are described with reference to the accompanying drawings. It should be noted that the same components are given the same reference numerals throughout the drawings, and the explanation thereof is omitted.

### Configuration of Storage System 1

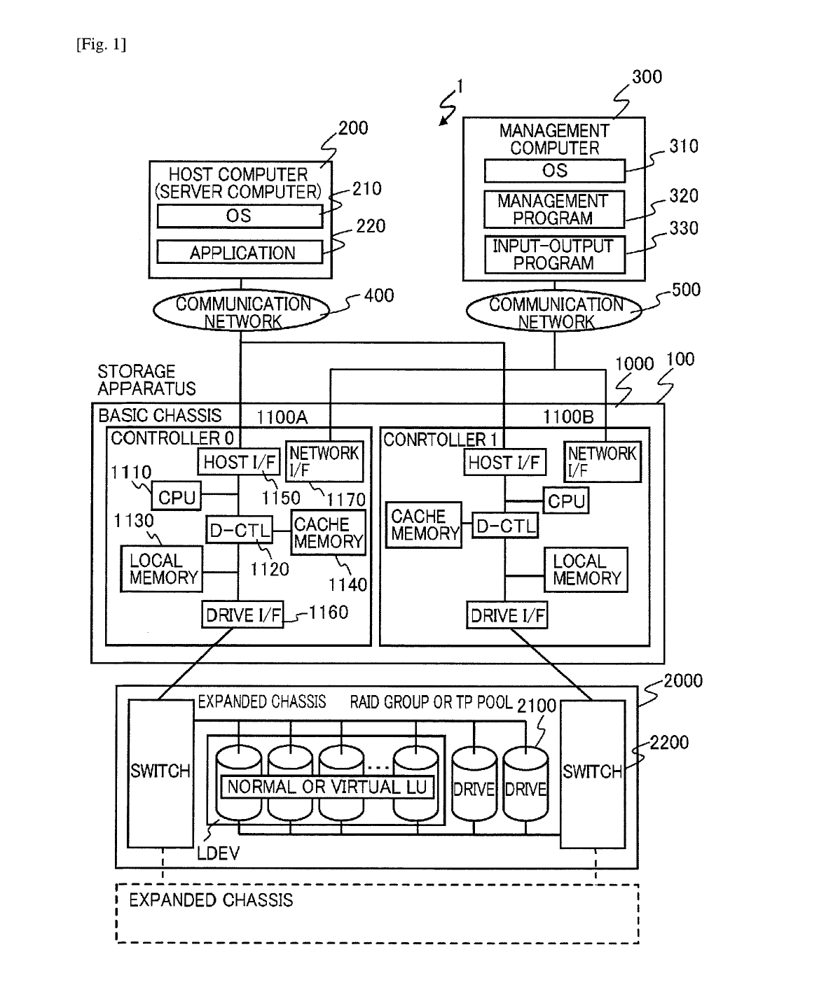

A configuration of a storage system 1 according to an embodiment of the present invention is described. FIG. 1 illustrates a configuration example of the storage system 1 according to an embodiment of the present invention.

The storage system 1 illustrated in FIG. 1 includes a storage apparatus 100, a host computer (hereinafter referred to as the “host”) 200, a management computer 300, and communication networks 400, 500. The storage apparatus 100 is communicatively coupled to the host 200 and the management computer 300 via the communication networks 400, 500, respectively.

The storage apparatus 100 provides the host 200 in the storage system 1 with storage areas as storage locations for data to be processed by the host 200. The storage apparatus 100 includes storage control units 1100A, 1100B and a storage drive 2000. The storage control units 1100A, 1100B are computer processing units each configured to execute processing for data input-output requests for the host 200 and execute data input-output control processing on the storage drive 2000 according to the data input-output requests. Here, in the example in FIG. 1, the storage control units 1100A, 1100B form a dual system for enhancing the availability of the storage system 1, and have the same configuration. In the following description, the name “storage control unit 1100” is used to indicate each of the storage control units 1100A, 1100B.

The storage control unit 1100 includes a processor 1110, a data transfer circuit unit 1120, a local memory 1130, a cache memory 1140, a host interface unit (hereinafter referred to as the “host IF unit”) 1150, a drive interface unit (hereinafter referred to as the “drive IF unit”) 1160, and a network interface unit (hereinafter referred to as the “network IF unit”) 1170. The processor 1110 is a unit to execute various programs for implementing a data input-output control function and the like between the host 200 and the storage drive 200, to be described later, and is formed as, for example, a CPU (Central Processing Unit), or a MPU (Micro Processor Unit). In the present specification, the processor is simply referred to as the “CPU.”

The data transfer circuit unit 1120 is a unit to execute data transfer between the drive IF unit 1160 and the cache memory 1140 and between the cache memory 1140 and the host IF unit 1150 under the management of the CPU 1110, and is formed of, for example, an ASIC (Application Specific Integrated Circuit).

The local memory 1130 is a memory to store various programs for implementing functions as the storage control unit 1100 for data input-output control processing and the like, and to store data such as parameters and various tables used during the execution of the programs, and is formed of a memory element such as a ROM (Read Only Memory), a RAM (Random Access Memory), or a flash memory. The cache memory 1140 is a storage area to temporarily store write data to the storage drive 2000 and read data from the storage drive 2000, which are described later, and is formed of, for example, a memory element such as a RAM. The cache memory 1140 has a memory space partitioned into a write side that is a storage area for storing write data, and a read side that is a storage area for storing read data.

Moreover, the memory space of the cache memory 1140 including the read side and the write side is set to include an un-compressed memory area, a compressed memory area, and a read cache area. The un-compressed memory area is an area for storing un-compressed data, the compressed memory area is an area for storing compressed data, and the read cache area is an area for storing read data that is read from the storage drive 2000 and decompressed. In addition, part of the memory area of the cache memory 1140 is set as a shared memory to be shared with the other storage control unit 1110. Thus, even when a failure occurs in any one of the storage control units 1100, the other storage control unit 1100 can take over control information stored in the shared memory and continue the operations as the storage apparatus 100.

The host IF unit 1150 is a unit functioning as an interface between the host 200 and an internal network in the storage control unit 1100. The host IF unit 1150 is formed using a unit in conformity with the standard of the communication network 400 that communicatively couples the host 200 and the storage control unit 1100 to each other. In the case where the communication network 400 is formed as a SAN (Storage Area Network) using Fibre Channel (FC), an FC adapter is provided as the host IF unit 1150. The drive IF unit 1160 is a unit functioning as an interface between the storage drive 2000 and the internal network in the storage control unit 1100. The drive IF unit 1160 is formed using a unit having functions in conformity with a network interface (FC, SAS, SATA or the like) employed between the storage control unit 1100 and the storage drive 2000. The network IF unit 1170 functions as an interface between the communication network 500 and the internal network in the storage control unit 1100. In the case where the communication network 500 is formed as a LAN employing the standard such as iSCSI, a NIC (Network Interface Card) is used as the network IF unit 1170.

The storage drive 2000 is a storage device to generate storage areas to be provided by the host 200 to external clients, and can be formed of any of suitable storage devices 2100 including a hard disk drive (HDD), a semiconductor storage drive (Solid State Drive, SSD) and the like. A switch 2200 is a unit to perform communication control for data input-output between the drive IF unit 1160 of the storage control unit 1100 and the storage devices 2100. In the storage drive 2000, a plurality of storage devices 2100 form a RAID group or a thin provisioning pool (hereinafter referred to as the “TP pool”). The RAID group is formed of a plurality of storage devices 2100 in combination to provided redundancy to stored data and is operated in the form where the stored data are given parities, as has been known heretofore. The TP pool is a set of a large number of unit logical storage areas (hereinafter referred to as the “pages”) with small storage capacities generated from physical storage areas provided by a plurality of storage devices 2100, and provides the host 200 with a necessary storage capacity according to a data write request from the host 200. Logical volumes (hereinafter referred to as “LUs”) recognizable by the host 200 as logical storage areas for data storage are generated from the RAID group or the TP pool. In the present specification, a normal LU denotes a LU generated from the RAID group, whereas a virtual LU denotes a LU generated from the TP pool. In the example in FIG. 1, the storage drive 2000 is provided in an expanded chassis different from a basic chassis in which the storage control unit 1100 is housed. The storage drive 2000, however, may be housed in the basic chassis as well.

Next, description for the host 200 is provided. The host 200 is a computer to execute various kinds of data processing according to instructions from users. The host 200 can be formed as a general computer having a function to communicate over the communication network 400 and including a CPU, a memory, a storage drive, an input device and an output device. Instead of the CPU, another processing device such as a MPU may be used. The memory is a memory to store various programs to implement functions as the host 200 and data such as parameters and various tables used during the execution of the programs, and is formed of a memory element such as a ROM, a RAM or a flash memory. The storage drive can be formed with suitable storage devices including a HDD, a SSD and the like. The input device is a data input device used in a general computer and may include, for example, appropriate input devices selected from a keyboard, a mouse, a touch screen, a pen tablet and the like. The output device is a data output device used in a general computer, and may include output devices such as a display monitor and a printer.

As illustrated in FIG. 1, the host 200 includes an OS 210 and an application 220. The OS 210 is basic software serving as an execution platform for various programs to run on the host 200. Any OS selected from various general computer OSs can be used as the OS 210. Under the control of the OS 210, the data I/O processing for the programs running on the host 200 is executed. The application 220 is a program to implement various data processing functions as the host 200. The application 220 uses, as a data storage location, a normal LU or a virtual LU provided by the storage apparatus.

Next, description for the management computer 300 is provided. The management computer 300 has a function to manage the operation status of the storage apparatus 100 in the storage system 1, and can be formed as a general computer, as in the case with the host 200, having a function to communicate with the communication network 500, and including a CPU, a memory, a storage drive, an input device and an output device. As illustrated in FIG. 1, the management computer 300 includes an OS 310, a management program 320, and an input-output program 330. The OS 310 is basic software serving as an execution platform for various programs to run on the management computer 300. Any OS can be selected from various general computer OSs to be used as the OS 310. Under the control of the OS 310, the data I/O processing for the programs running on the management computer 300 is executed. The management program 320 executes processing to give various operational commands to the storage apparatus 100 via the communication network 500 and to monitor the operation status of each component in the storage apparatus 100 also via the communication network 500. The input-output program 330 is a program to execute data input-output processing on the management program 320 through the input device or the output device of the management computer 300, and a web browser in an appropriate format, for example, may be used as the input-output program 330.

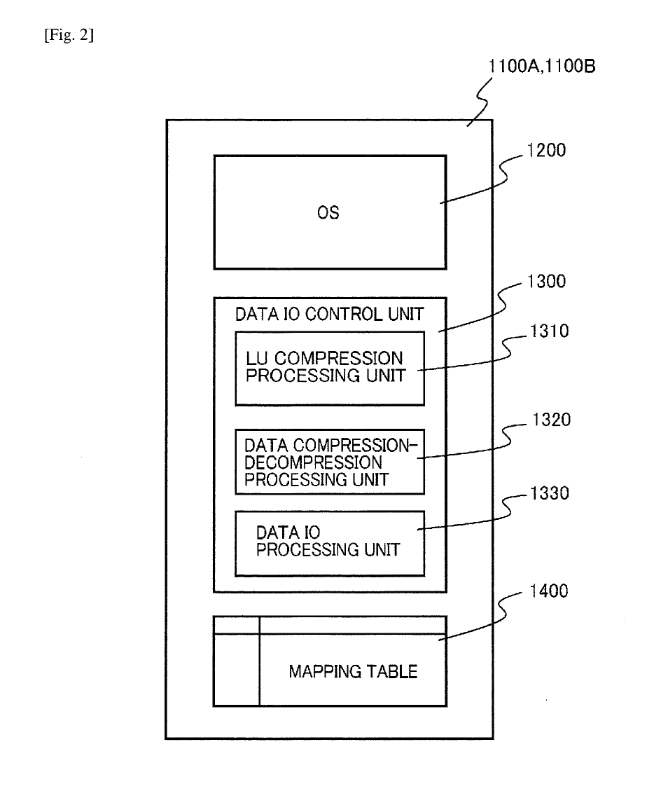

Hereinbelow, a software configuration of the storage control unit 1100 in the storage apparatus 100 is described. FIG. 2 illustrates a software configuration example of the storage control unit 1100. The storage control unit 1100 includes an OS 1200, and a data input-output control unit (hereinafter referred to as the “data IO control unit”) 1300. The OS 1200 is basic software serving as an execution platform for various programs to run on the storage apparatus 100. Any OS can be selected from various general computer OSs and can be used as the OS 1200. The data IO control part 1300 is a program to execute data IO processing on the storage drive 2000 under the control of the OS 1200. The data IO processing herein includes processing for a data IO request from the host 200 and data processing such as data compression-decompression processing related to the embodiment of the present invention. In the storage control unit 1100, a mapping table 1400 to which the data IO control part 1300 makes reference is set. The mapping table 1400 is a table keeping mapping between a logical block address (LBA) of data stored in the storage drive 2000 and a data storage location of the data in the compression LU. The mapping table 1400 may be stored in the shared memory set in the cache memory 1140 of the storage control unit 1100, for example. Description of the mapping table 1400 is given later. It should be noted that various kinds of software necessary to control the storage apparatus 100 can be installed in the storage control unit 1100 and is not limited to those in the example shown in FIG. 2.

In the present embodiment, the data IO control part 1300 includes a LU compression processing unit 1310, a data compression-decompression processing unit 1320, and a data IO processing unit 1330. The LU compression processing unit 1310 is a unit that executes processing in which a LU, i.e., a logical storage area of the storage apparatus 100 used by the host 200 as a data storage area, is compressed for efficient utilization of the storage capacity of the storage drive 2000. The data compression-decompression processing unit 1320 is a unit that executes data compression processing needed in writing data to a compressed LU and data decompression processing needed in reading data from a compressed LU according to data IO requests from the host 200. The data IO processing unit 1330 is a unit that executes other kinds of data IO processing onto the storage drive 2000 according to data IO requests from the host 200. Functions of the LU compression processing unit 1310, the data compression-decompression processing unit 1320, and the data IO processing unit 1330 is described later with reference to processing flow examples and the like.

Configuration of Logical Storage Area

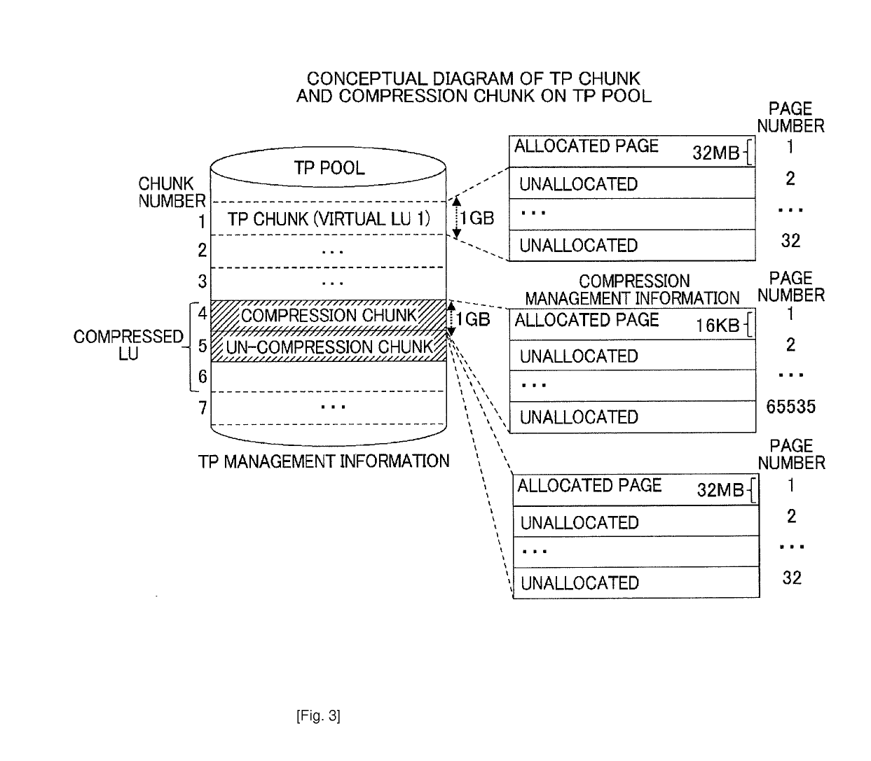

Hereinafter, description is provided for a configuration of a logical storage area provided by the storage apparatus 100 in the present embodiment. FIG. 3 illustrates a configuration example of the TP pool according to the present embodiment. The TP pool includes a plurality of TP chunks. The TP chunk includes a large number of sets of unit logical storage areas called pages. In the example of FIG. 3, each page has a storage capacity of 32 MB. A LU being a logical storage area for the host 200 is formed as a virtual LU. One virtual LU includes one or more TP chunks. Each TP chunk includes 32 pages and has a storage capacity of 1 GB in the present embodiment. In the example of FIG. 3, the TP chunk identified with a chunk number 1 provides a virtual LU1 and a storage capacity of 1 GB is reserved as a single virtual LU. However, each page actually allocated to the host is when the page allocation is needed upon receipt of a data write request from the host 200. Thus, the physical storage areas of the storage drive 2000 are efficiently utilized depending on the data storage state of the host 200. In FIG. 3, a page where data is stored is indicated as “allocated page.”

Next, description of the compression LU is given. As illustrated in FIG. 3, the compression LU uses as a logical storage area for storing data compressed by using appropriate data compression algorithm, a data storage area used by a virtual LU allocated to the host 200. One compression LU may include both a compression chunk and an un-compression chunk. In the example of FIG. 3, a single compression chunk has a storage area of 1 GB including 65536 pages each of which is a unit logical storage area set to have a storage capacity of 16 KB. On the other hand, the uncompression chunk includes 32 pages each having a storage capacity of 32 MB, as is the case with the normal TP chunk. In this way, the storage capacity of a virtual page in information for managing storage targets of compressed data is set smaller than the storage capacity of a virtual page in information for managing storage targets of uncompressed data. This enables efficient utilization of resources (the cache memory and the local memory) of the storage apparatus 100 in read and write processing on compressed data.

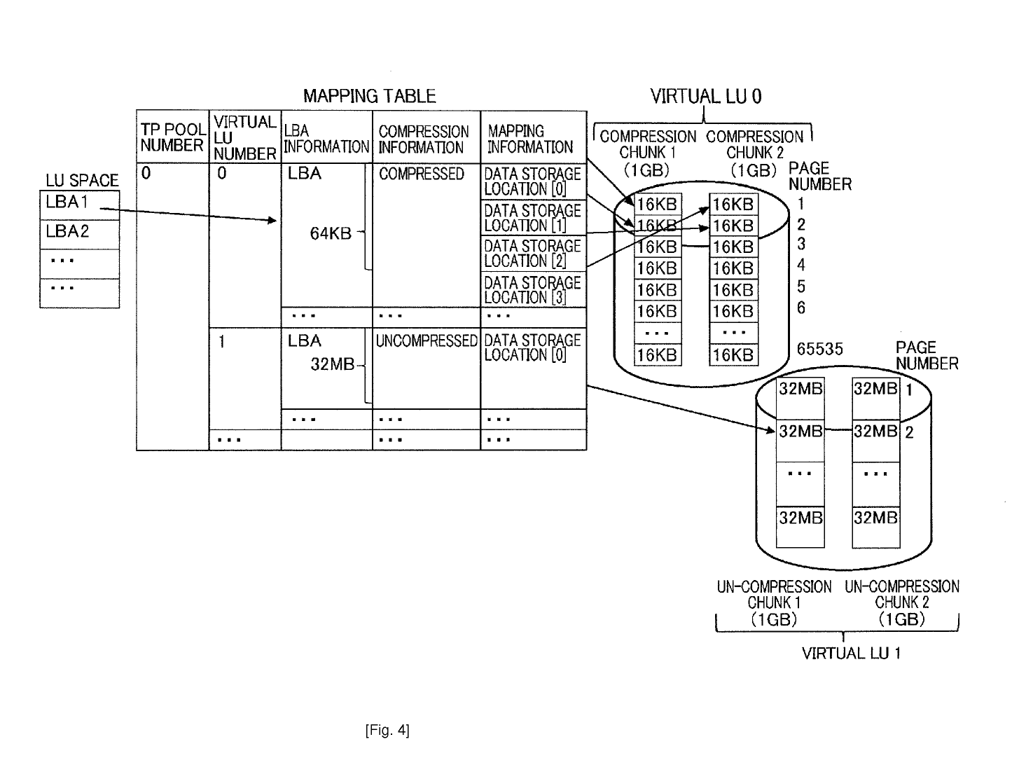

FIG. 4 schematically illustrates mapping between a logical block address space allocated as a data storage area for the host 200 and each of a compression chunk and an un-compression chunk (normal TP chunk). In the present embodiment, the LBA of a virtual LU for managing data of the host 200 has a data size of 64 KB. Hence, for a compression chunk, the data of a single LBA is assigned storage areas for 4 pages. In the example of FIG. 4, the data stored at the LBA 0 to 63 KB of the virtual LU are stored in pages 1 and 2 of the compression chunk 1 and pages 1 and 2 in the compression chunk 2 in the virtual LU0. The LBA of the virtual LU and the page in the compression chunk is associated with each other in a mapping table 1400.

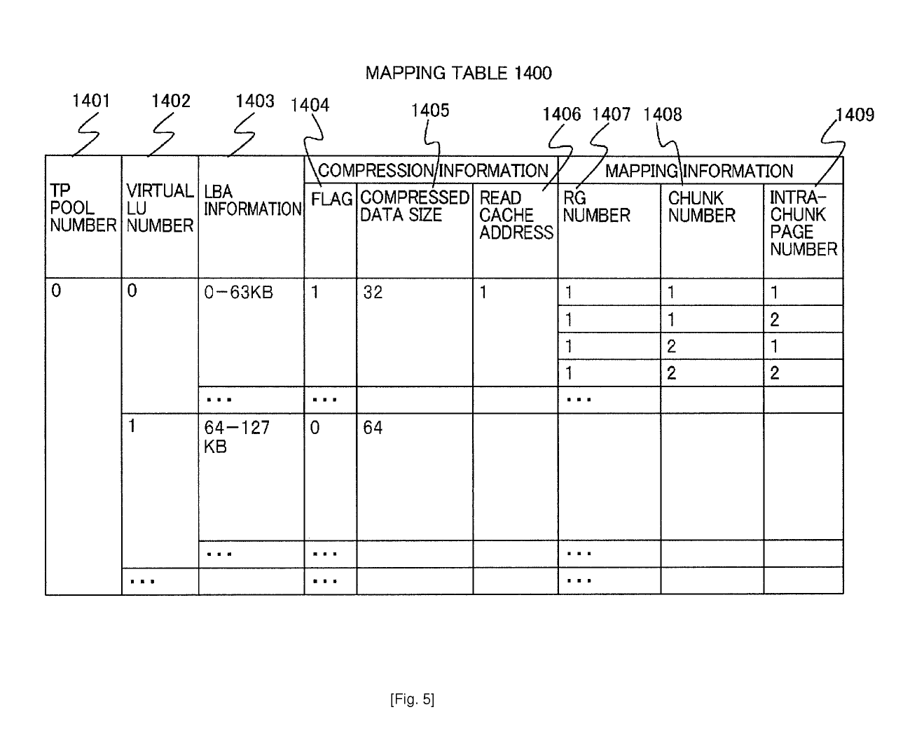

FIG. 5 illustrates a configuration example of the mapping table 1400 in the present embodiment. The mapping table 1400 illustrated in FIG. 5 includes recorded items of TP pool number 1401, virtual LU number 1402, LBA information 1403, compression information status flag 1404, compressed data size 1405 and intra-read cache address 1406, and RG number 1407 as mapping information, chunk number 1408, and intrachunk page number 1409. The TP pool number 1401 is an identifier for uniquely identifying the TP pool that is a set of virtual pages provided by the storage drive 2000 of the storage apparatus 100. The virtual LU number 1402 is an identifier for uniquely identifying the virtual LU provided to the host 200 by the storage apparatus 100. The LBA information 1403 is an address indicating a storage location of data stored in the virtual LU by the host 200. The compression information status flag 1404, the compressed data size 1405, and the intra-read cache address 1406 indicate information on data identified by the associated LBA information 1403, i.e., respectively indicate a flag representing whether the data is compressed or uncompressed, the size of the compressed data, and the address in the read cache set up in the cache memory 1140. The intra-read cache address 1406 is recorded when the read data read from the compression LU and then decompressed is stored in the read cache of the cache memory 1140. The status flag 1404 is set to 1 when the data associated with the LBA information 1403 is already compressed, and is set to 0 when the data is uncompressed, for example. Note that, in background compression of a virtual LU to be described later, uncompressed data in the LU where the compression processing is in progress is assigned the status flag 1404 indicating that status and thereby is protected until completion of storing the data in the compression chunk. Such uncompressed data to be protected is referred to as “old data,” below. The RG number 1407, the chunk number 1408, and the intra-chunk page number 1409 as the mapping information respectively indicate an identifier for uniquely identifying each RAID group generated by the storage drive 2000 of the storage apparatus 100, a chunk number representing a storage location where the data identified by the associated LBA information 1403 is stored, and a page representing the storage location in the chunk.

Outline of the Operations of Storage System 1

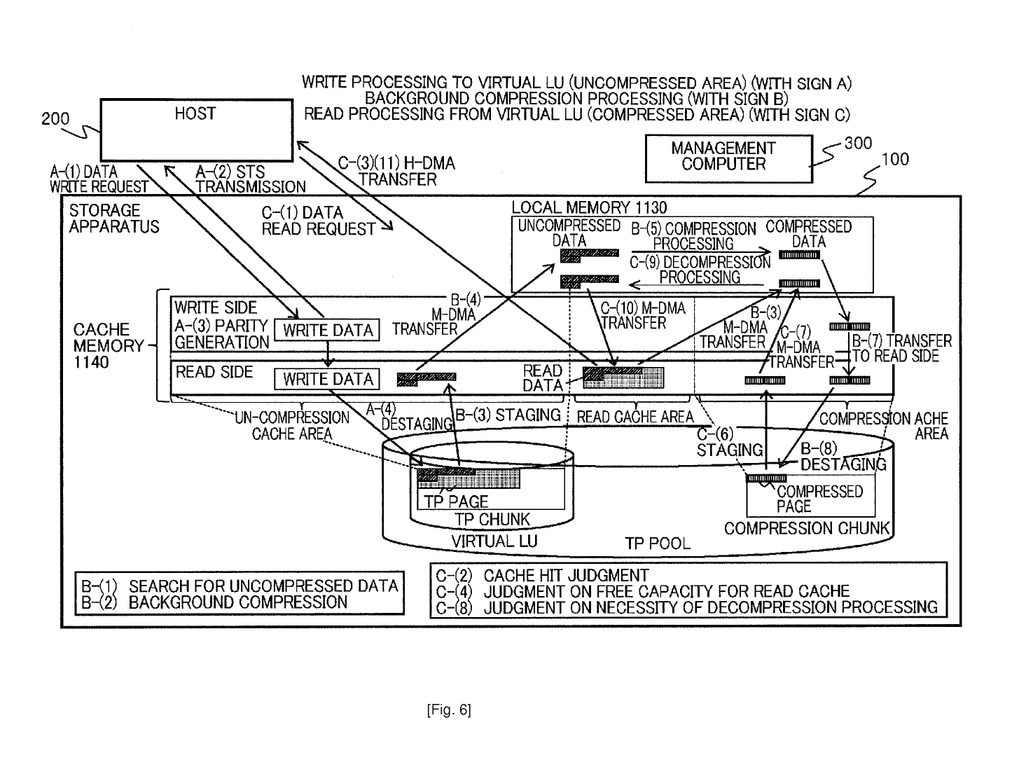

Hereinbelow, description will be given of an outline of data processing executed by the storage system 1 having the foregoing configuration in the present embodiment. FIG. 6 schematically illustrates an outlines of the data processing executed by the storage system 1 in the present embodiment. More specifically, FIG. 6 illustrates an outline of processing of writing data onto an uncompressed area in a virtual LU of the storage apparatus 100 in response to a data write request from the host 200, processing of compressing an uncompressed area of a virtual LU which runs in the background after the data write processing, and processing of reading data from a compressed area of a virtual LU in response to a data read request from the host 200. In FIG. 6, the sending and receiving of commands and data between components in the storage system 1 are indicated by arrows and actions in data processing executed by each component is indicated with an identification sign assigned thereto. As the identification signs, A-(1) and the like are used for the data write processing, B-(1) and the like are used for the background compression processing, and C-(1) and the like are used for the data read processing.

Processing for Data Write Request from Host 200

First of all, explanation of data write processing will be given. When receiving a data write request from the host 200 (A-(1)), the storage apparatus 100 returns to the host 200 a status signal (STS signal) indicating that the data write request is received (A-(2)). In the storage apparatus 100, the write data contained in the data write request received from the host 200 is stored in the write side of the cache memory 1140 in the storage control unit 1100. The storage control unit 1100 generates a predetermined parity, gives the parity to the write data, and then moves the write data to the read side of the cache memory 1140 (A-(3)). The write data written in the read side is written to a TP chunk (un-compression chunk) used by the host 200 at an appropriate timing (A-(4)). Hereinafter, the reading of data from the storage area of the storage apparatus 100 to the cache memory 1140 is referred to as “ staging,” whereas the writing of data from the cache memory 1140 to the storage area of the storage apparatus 100 is referred to as “destaging”.

Here, in the embodiment of FIG. 6, the processing of uncompressed data is performed in units of 64 KB. Thus, the data size of data decompressed on the local memory 1130 is 64 KB. The local memory 1130 has a smaller storage capacity than the cache memory 1140, and is also used for internal control other than the data compression and decompression functions. On the other hand, the cache memory 1140 manages data in units of 32 MB. If a unit of data in the cache memory 1140 is subjected as a whole to the data compression/decompression processing, the storage capacity of the local memory 1130 may be constricted. For this reason, the unit of data management in the local memory 1130 is set to 64 KB, so that data processing can be stably executed on the local memory 113. Moreover, the data compression/decompression processing is considered to be more efficient when performed in small units of 64 KB than in large units of 32 MB.

Background Compression Processing of Uncompressed Area in Virtual LU

Next, description will be given of the background compression processing of an uncompressed area in a virtual LU. Firstly, the storage control unit 1100 of the storage apparatus 100 searches the virtual LU for uncompressed data according to an execution condition preset in the data IO processing unit 1330, for example, and starts background compression processing if uncompressed data is found (B-(1), (2)). Then, the storage control unit 1100 stages the data judged as being uncompressed to the read side of the cache memory 1140, and transfers the data to the local memory 1130 by M-DMA transfer (B-(3), (4)). The M-DMA transfer is data transfer processing between the cache memory 1140 and the local memory 1130 executed by the processor 1110. Thereafter, the uncompressed data transferred from the cache memory 1140 is compressed on the local memory 1130 and then the compressed data is transferred from the local memory 1130 to the write side of the cache memory 1140 (B-(5), (6)). The compressed data is transferred from the write side to the read side of the cache memory 1140, and then destaged to the compression chunk at an appropriate timing (B-(7), (8)).

Processing for Data Read Request from Host 200

Hereinbelow, description of read processing of compressed data will be given. Firstly, when receiving a data read request from the host 200 (C-(1)), the storage control unit 1100 of the storage apparatus 100 refers to the read cache area in the cache memory 1140 to judge whether or not the read data in the data read request is already cached (cache hit) (C-(2)). In the case of a cache hit, the hit data is transferred to the host 200 by H-DMA transfer (C-(3)). The H-DMA transfer is data transfer executed by the processor 1110 between the cache memory 1140 and the host 200. In the case of a cache miss for the read data, the storage control unit 1100 checks whether or not the cache memory 1140 has a free storage capacity available to the read data, reserves the storage capacity for the read data in the cache memory 1140, if necessary, and then stages the read data from the compression chunk (C-(4), (5), (6)). Thereafter, the storage control unit 1100 transfers the staged read data on the read side of the cache memory 1140 to the local memory 1130, and performs decompression processing of the read data according to a result of judgment as to whether or not the data decompression processing needs to be performed (C-(7), (8), (9)). The read data decompressed on the local memory 1130 is transferred to the read side of the cache memory 1140 and then transferred to the host 200 (C-(10), (11)).

As has been described above, in the storage system 1 of the present embodiment, the read cache area for storing read data is set up in the cache memory 1140, and thereby the data read processing from the compression LU can be carried out by using data in the read cache while skipping the data decompression processing and destaging. This speeds-up the processing for the data read request from the host 200.

Data Processing by Storage Control Unit 1100 in Storage Apparatus 100

Based on the foregoing outline of the data processing in the storage system 1, description will be given of data processing executed by the storage control unit 1100 in the storage apparatus 100.

Initial Compression Processing on Virtual LU

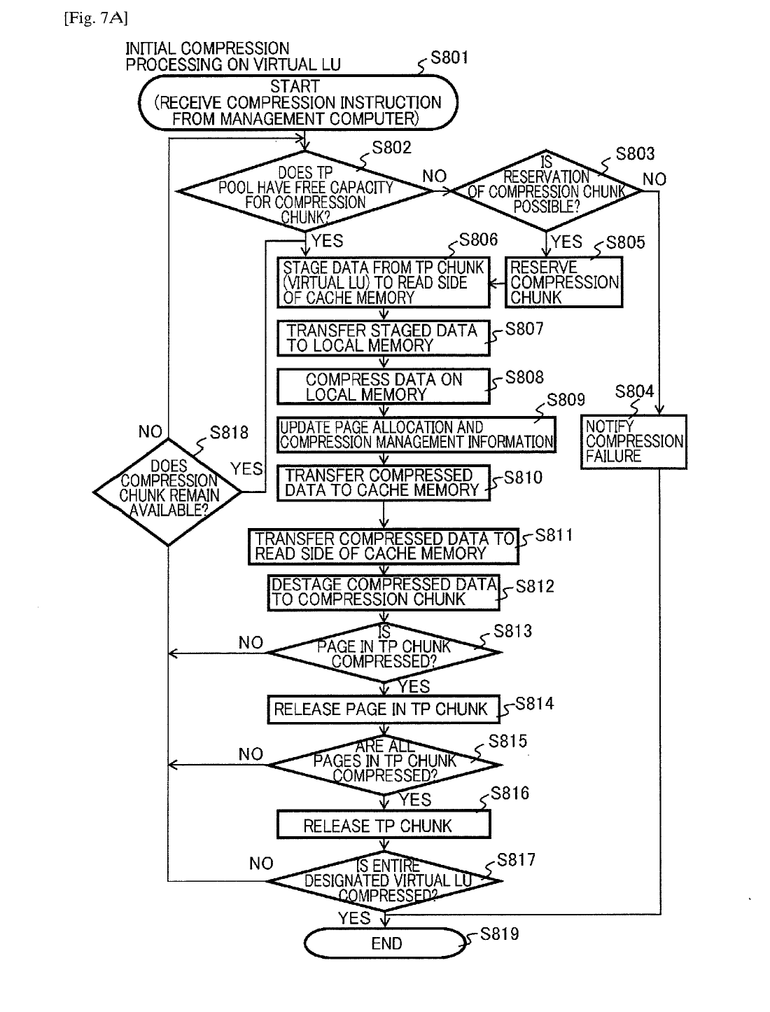

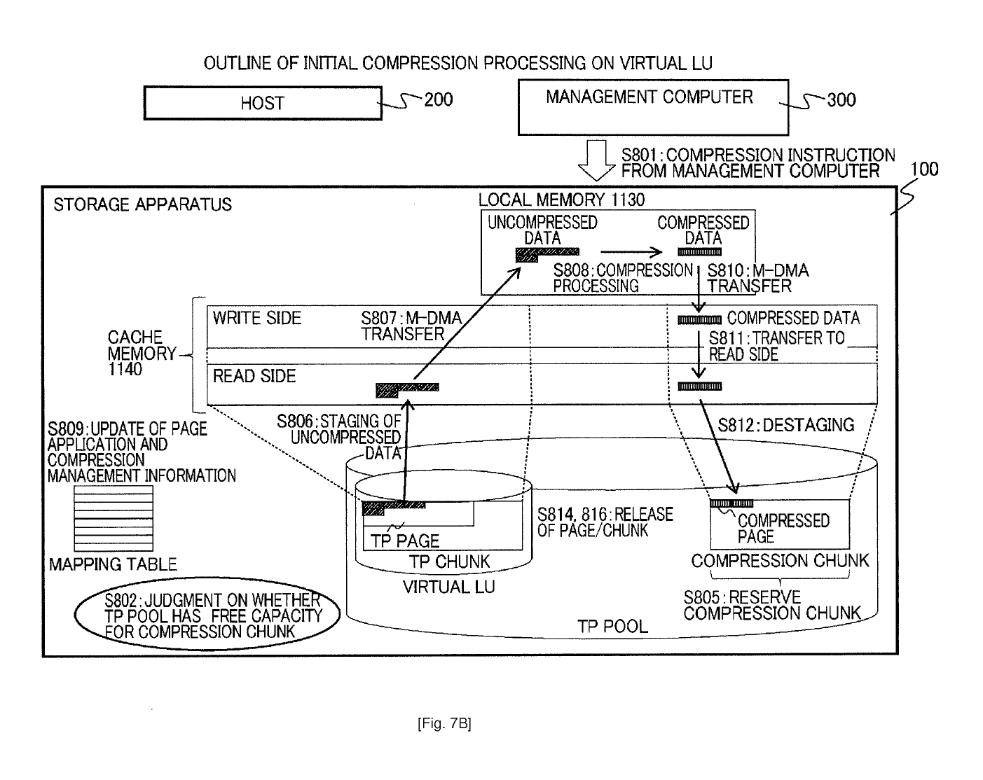

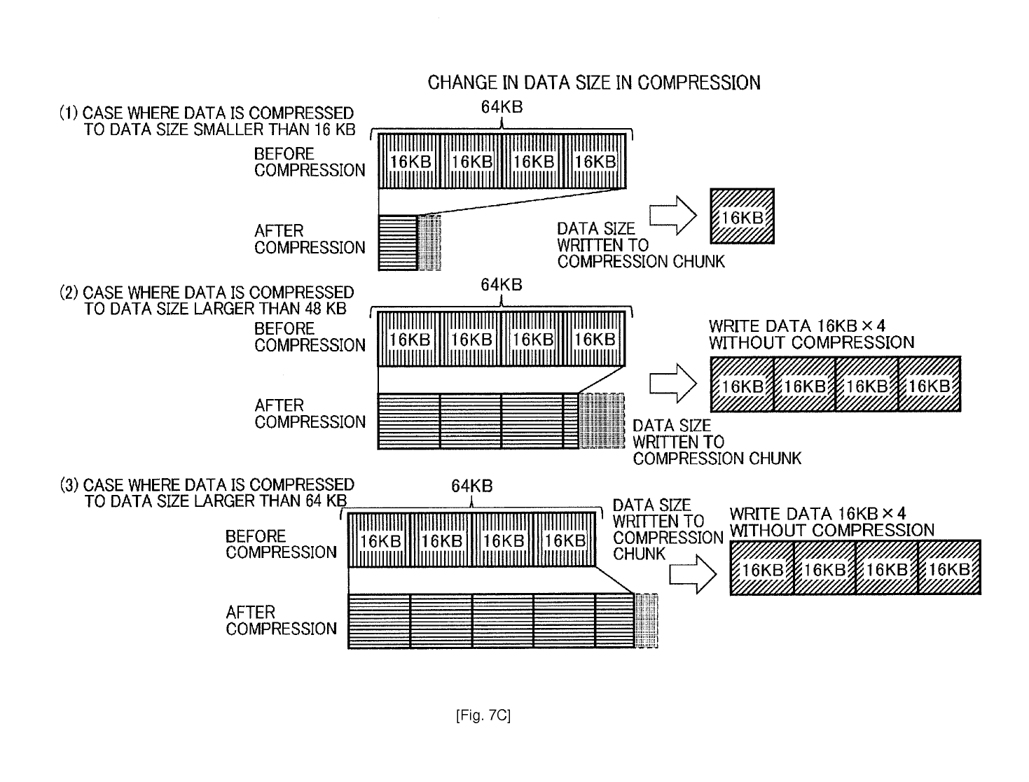

To begin with, description will be given of initial compression processing on a virtual LU used by the host 200. FIG. 7A illustrates a flow example of initial compression processing on a virtual LU, and FIG. 7B illustrates an outline of the initial compression processing on a virtual LU. The outline in FIG. 7B is correspond to the outline of the operations in the storage system 1 in FIG. 6, and exemplifies how commands and data are sent and received in the storage system 1 when the processing flow in FIG. 7A is executed. The compression processing on a virtual LU is processing of compressing an un-compression chunk in a virtual LU, and is started (S801) when the LU compression processing unit 1310 in the storage control unit 1100 receives a compression processing start instruction issued from the management computer 300 by a manager. The compression processing start instruction includes designations of a LU to be compressed, compression algorithm to be applied, a priority of the compression processing over the other tasks of the storage control unit 1100, and the like, for example.

The LU compression processing unit 1310 judges whether or not the TP pool has a free storage capacity available as a compression chunk (S802), and further judges whether or not reservation of a compression chunk is possible when judging that free storage capacity is not available (S802: No, S803). Then, when judging that the reservation of the compression chunk is not possible (S803: No), the LU compression processing unit 1310 notifies the management computer 300 of a failure of the compression processing and terminates the processing (S804, S819). When judging that the reservation of the compression chunk is possible (S803: Yes), the LU compression processing unit 1310 reserves the compression chunk and advances the processing to S806.

When judging that the existing compression chunk has free storage capacity in S802 (S802: Yes), the LU compression processing unit 1310 stages the compression target data in a unit of fixed size from the TP chunk to the read side of the cache memory 1140 (S806). The LU compression processing unit 1310 transfers the staged data to the local memory 1130, and performs the data compression processing on the local memory 1130 by using certain data compression algorithm designated by the management computer 300 (S808). The LU compression processing unit 1310 updates the page allocation and compression management information associated with the LBA information in the mapping table 1400 (S809). Here, the page allocation to the compression chunk is performed according to the size of the compressed data. Then, the LU compression processing unit 1310 transfers the compressed data to the write side of the cache memory 1140, followed by moving the data to the read side (S810, S811). The LU compression processing unit 1310 destages the compressed data from the read side of the cache memory 1140 to the compression chunk (S812). In this way, the uncompressed data of the unit data size (64 KB in the present embodiment, for example) is compressed.

Here, explanation will be given of the data size during data compression processing in the present embodiment. FIG. 7C illustrates a change in the data size by data compression processing in the present embodiment. Uncompressed data is handled in a data size unit of 64 KB. Compressed data is divided by 16 KB and is stored in a compression chunk. Thus, the maximum compression ratio is 1/4 (=16 KB/64 KB). Note that the unit data sizes of compressed data and uncompressed data are not limited to those in this example.

When the data size after the compression processing is smaller than 16 KB, the data is stored in a storage area of 16 KB in the compression chunk since the unit data size for storage in the compression chunk is 16 KB. The part of the data of 16 KB not occupied by the compressed data is padded with appropriate data in padding processing. In this case, the data is compressed at the maximum data compression ratio.

On the other hand, when the data size after compression processing is more than 48 KB, the data of 64 KB (16 KB*4) is stored in the compression chunk. In this case, since the data before and after the compression processing has the same data size in the compression chunk, the data of 64 KB in the uncompressed state is written to the compression chunk.

When the data size of data after the compression processing is more than 64 KB, the data of 64 KB in the uncompressed state is written to the compression chunk.

Then, the LU compression processing unit 1310 judges whether or not the page of the TP chunk to be compressed is already compressed (S813). When judging that the page is not compressed yet, the LU compression processing unit 1310 further judges whether or not the compression chunk still remains available (S818). When judging that the compression chunk remains available (S818: Yes), the LU compression processing unit 1310 advances the processing to S806 and stages next uncompressed data of a fixed size into the cache memory 1140. On the other hand, when judging that the compression chunk does not remain available (S818: No), the LU compression processing unit 1310 advances the processing to S802, and again checks whether or not a necessary storage capacity is free in the TP pool.

When judging that the page in the TP chunk is already compressed in S813 (S813: Yes), the LU compression processing unit 1310 releases the already-processed page in the TP chunk, and judges whether or not all the pages in the TP chunk are already compressed (S815). When judging that there is a page yet to be compressed in the TP chunk (S815: No), the LU compression processing unit 1310 advances the processing to S818. When judging that all the pages in the TP chunk are already compressed in S815 (S815: Yes), the LU compression processing unit 1310 releases the TP chunk (S816), and judges whether or not the entire designated virtual LU is compressed (S817). When judging that the entire designated virtual LU is compressed (S817: Yes), the LU compression processing unit 1310 terminates the processing (S819) since the compression processing directed by the management computer 300 is completed. When judging that there is a TP chunk yet to be compressed in the designated virtual LU (S817: No), the LU compression processing unit 1310 advances the processing to S818.

Through the foregoing processing, the data compression processing of a desired virtual LU provided to the host 200 can be executed.

Initial Compression Processing on Normal LU

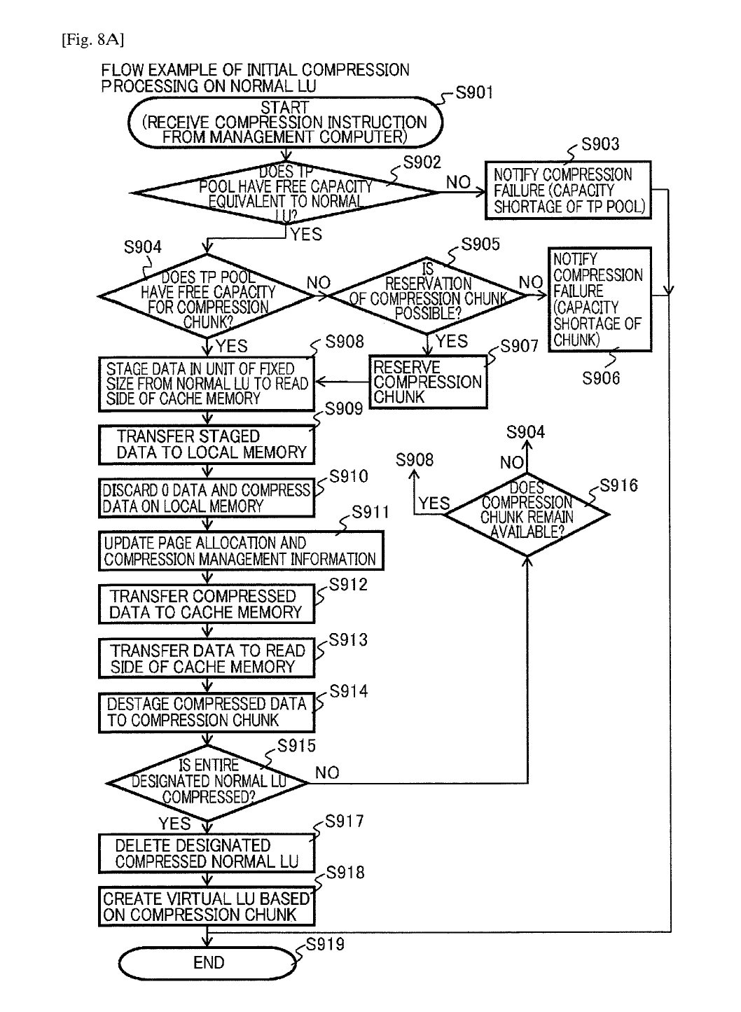

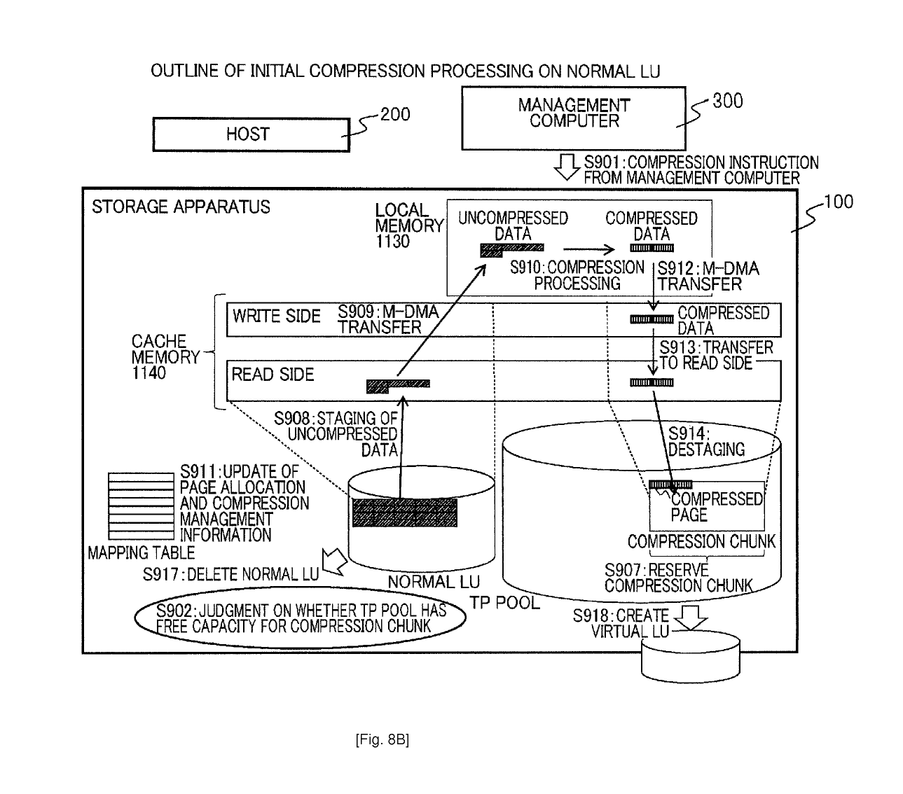

Next, description is given of initial compression processing on a normal LU used by the host 200. FIG. 8A illustrates a flow example of initial compression processing on a normal LU and FIG. 8B illustrates an outline of the compression processing on a normal LU. The outline in FIG. 8B is based on the outline of the operations in the storage system 1 in FIG. 6, and illustrates how commands and data are sent and received in the storage system 1 when the processing flow in FIG. 8A is executed. In the case of a normal LU, the normal LU is not deleted until the data stored in the entire storage area of the normal LU to be compressed is compressed. The initial compression processing on a normal LU is processing of compressing data stored in a logical storage area provided to the host 200 by the RAID group formed of the storage drive 2000 included in the storage apparatus 100. The initial compression processing on a normal LU is started (S901) when the LU compression processing unit 1310 in the storage control unit 1100 receives a compression processing start instruction issued from the management computer 300 by the manager, as in the case of a virtual LU. The LU compression processing unit 1310 judges whether or not the TP pool has a free capacity equivalent to the storage capacity of the normal LU to be compressed (S902). When judging that free storage capacity is not present (S902: No), the LU compression processing unit 1310 notifies the management computer 300 that the designated normal LU cannot be compressed, and terminates the processing. Here, free storage capacity equivalent to the storage capacity of the normal LU is reserved in consideration of the case where the data size is not reduced by the compression processing. When judging that the necessary storage capacity is free in S902 (S902: Yes), the LU compression processing unit 1310 judges whether or not the TP pool has a free storage capacity usable as a compression chunk (S904), and further judges whether or not reservation of a compression chunk is possible when judging that the free storage capacity is not available (S904: No, S905). Then, when judging that the reservation of the compression chunk is not possible (S905: No), the LU compression processing unit 1310 notifies the management computer 300 of a failure of the compression processing and terminates the processing (S906, S919). When judging that the reservation of the compression chunk is possible (S905: Yes), the LU compression processing unit 1310 reserves the compression chunk and advances the processing to S908 (S907).

When judging that there is a free storage capacity for the compression chunk in S904 (S904: Yes), the LU compression processing unit 1310 stages compression target data in a unit of fixed size from the normal LU to the read side of the cache memory 1140 (S908). The LU compression processing unit 1310 transfers the staged data to the local memory 1130, discards 0 data included in the compression target data on the local memory 1130, and performs data compression processing by using a predetermined data compression algorithm (S909, S910). The discarding of 0 data is one of functions of thin provisioning for effective utilization of the storage capacity by avoiding a storage area where pieces of 0 data are stored consecutively from being used as a data storage area. Thereafter, the LU compression processing unit 1310 updates the page allocation and the compression management information associated with the LBA information in the mapping table 1400 (S911). Then, the LU compression processing unit 1310 transfers the compressed data to the write side of the cache memory 1140 and thereafter moves the data to the read side (S912, S913). The LU compression processing unit 1310 destages the compressed data from the read side of the cache memory 1140 to the compression chunk (S914). In this way, the uncompressed data of a unit data size is compressed.

Next, the LU compression processing unit 1310 judges whether the entire normal LU designated in the compression instruction received from the management computer 300 is already compressed (S915), and further judges whether or not the compression chunk remains available (S916) when judging that the entire normal LU is not compressed yet (S915: No). When judging that the compression chunk remains available (S916: Yes), the LU compression processing unit 1310 advances the processing to S908, and stages the next uncompressed data of a fixed size to the cache memory 1140. On the other hand, when judging that the compression chunk does not remain available (S916: No), the LU compression processing unit 1310 advances the processing to S904, and again checks whether or not a necessary storage capacity is free in the TP pool.

When judging that the entire normal LU is already compressed (S915: Yes), the LU compression processing unit 1310 deletes the compressed normal LU (S917), creates a new virtual LU by using the created compression chunk, and terminates the processing (S918, S919).

Through the foregoing processing, a normal LU provided to the host 200 is compressed and converted into a virtual LU, and thereby the physical storage area allocated to the normal LU can be effectively utilized.

Data Read/Write Processing on Virtual LU during Compression

Hereinafter, description is given of data read/write processing performed on a virtual LU in the course of compression of data stored in the virtual LU.

Read Processing from Virtual LU during Compression

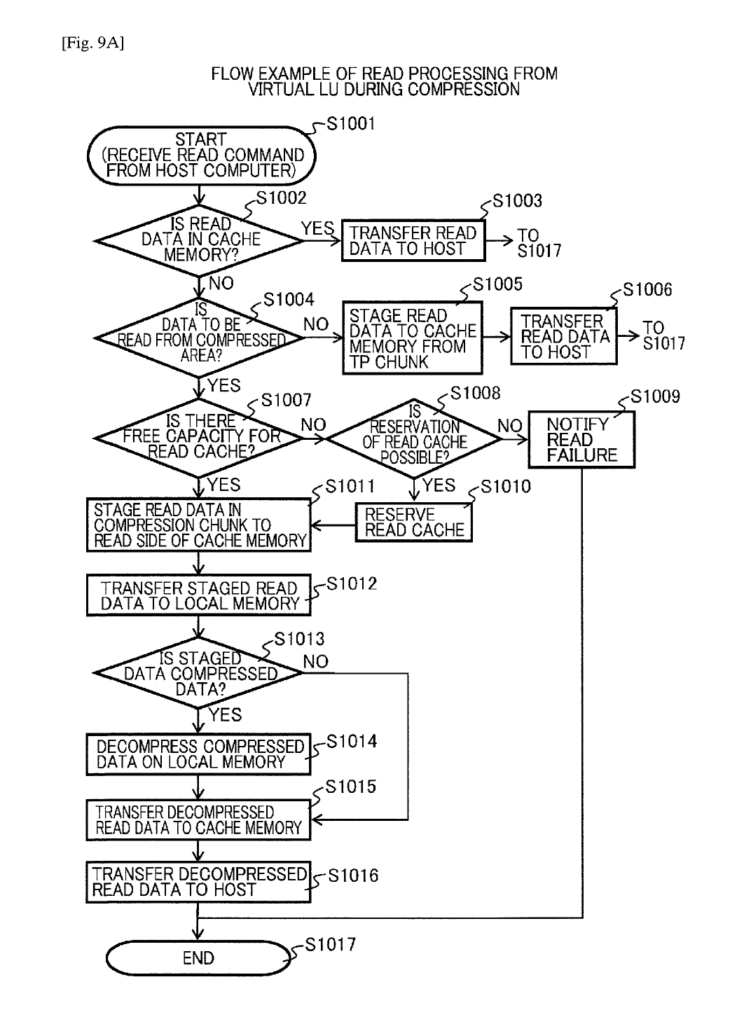

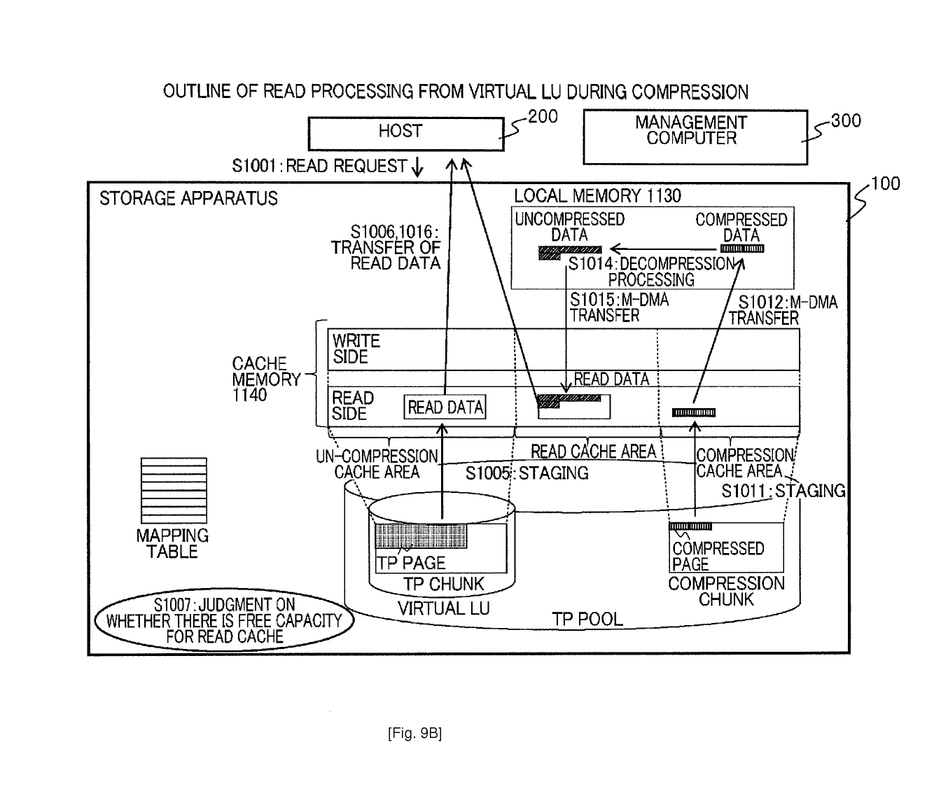

Firstly, processing of reading data from a virtual LU used by the host 200 will be explained. Since the compression processing on the virtual LU is running in this case, the virtual LU allocated to the host 200 contains both a compression chunk and an uncompression chunk as illustrated in FIG. 3. FIG. 9A illustrates a flow example of the data read processing from a virtual LU, and FIG. 9B illustrates an outline of the processing. The outline in FIG. 9B is based on the outline of the operations in the storage system 1 in FIG. 6, and illustrates how commands and data are sent and received in the storage system 1 when the processing flow in FIG. 9A is executed. This processing starts (S1001) when the data IO processing unit 1330 in the storage control unit 1100 in the storage apparatus 100 receives a data read request from the host 200. The data IO processing unit 1330 judges whether or not data designated by the data read request is stored in the cache memory 1140 (S1002). When judging that the read data is stored in the cache memory 1140 (S1002: Yes), the data IO processing unit 1330 transfers the read data in the cache memory 1140 to the host 200 and terminates the processing (S1003, S1017). When judging that the data read is not in the cache memory 1140 (S1002: No), the data IO processing unit 1330 judges whether or not the data designated by the data read request is stored in the compression chunk with reference to the mapping table 1400 (S1004). When judging that the data is not stored in the compression chunk (S1004: No), the data IO processing unit 1330 stages the read data from the TP chunk (un-compression chunk) to the read side of the cache memory 1140, transfers the read data to the host 200 and terminates the processing (S1006, S1017). When judging that the data is stored in the compression chunk (S1004: Yes), the data IO processing unit 1330 judges whether or not the TP tool has a free storage capacity usable as a read cache (S1007), and further judges whether or not reservation of a read cache is possible when judging that the free storage capacity is not present (S1007: No, S1008). When judging that the reservation of the read cache is not possible (S1008: No), the data IO processing unit 1330 notifies the management computer 300 of a read failure and terminates the processing (S1009, S1017). When judging that the reservation of the read cache is possible (S1008: Yes), the data IO processing unit 1330 reserves the read cache and advances the processing to S1011 (S1010). Here, in order to avoid a situation having a failure of the data read processing, a storage area for the read cache may be always set up in the cache memory 1140 instead of the step of judging whether or not the reservation of the read cache is possible in the cache memory 1140.

When judging that the free storage capacity for the read cache is present in S1007 (S1007: Yes), the data IO processing unit 1330 stages the read data in the compression chunk to the read side of the cache memory 1140 (S1011), and then transfers the read data to the local memory 1130 (S1012). Then, the data IO processing unit 1330 judges whether or not the staged read data is compressed data in reference to the mapping table 1400 (S1013). This judgment is set to recognize data written to the compression chunk without being compressed in data write processing as a result of the judgment that the data produces no effects of compression, and to skip the decompression processing of the uncompressed data in the read processing. When it is judged the staged read data is compressed (S1013: Yes), the data compression-decompression processing unit 1320 decompresses the read data on the local memory 1130 (S1014), and transfers the decompressed read data to the read side of the cache memory 1140 (S1015). Then, the data IO processing unit 1330 transfers the read data in the cache memory 1140 to the host 200 and terminates the processing (S1016, S1017). On the other hand, when judging that the staged data is not compressed in S1013 (S1013: No), the data IO processing unit 1330 skips S1014 and advances the processing to S1015.

Through the foregoing processing, in the case of reading data from a virtual LU during the compression processing, the loaded data stored in the cache memory 1140 can be used, and thereby the staging and the decompression processing of the compressed data do not have to be always performed in the data read processing. Thus, the data IO performance of the storage apparatus 100 is improved.

Write Processing to Virtual LU during Compression

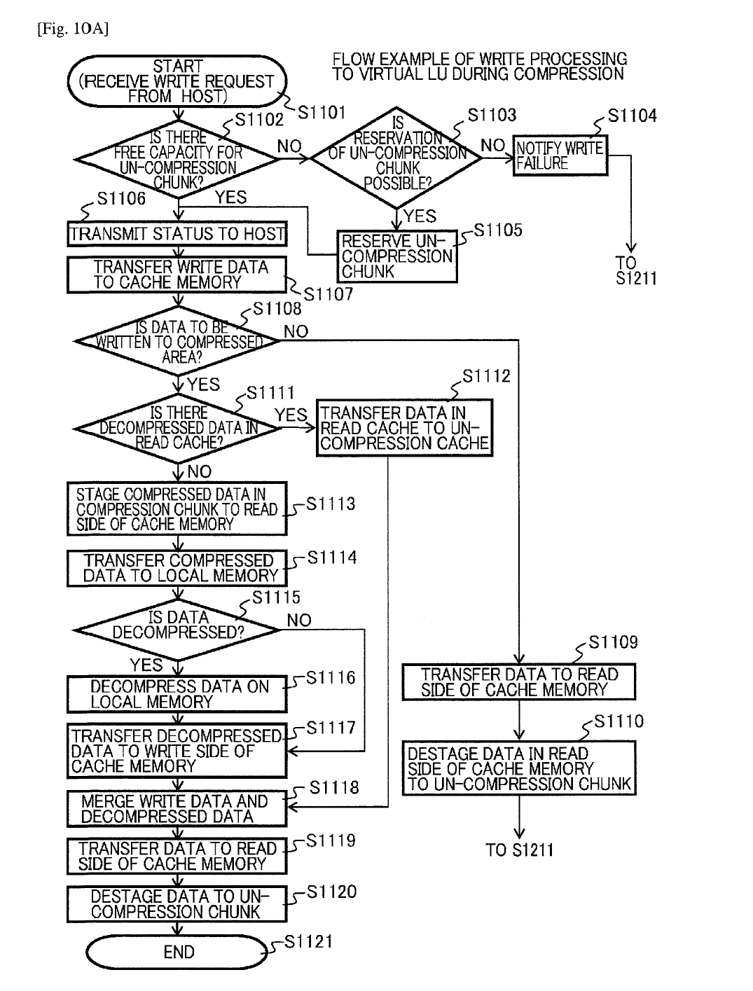

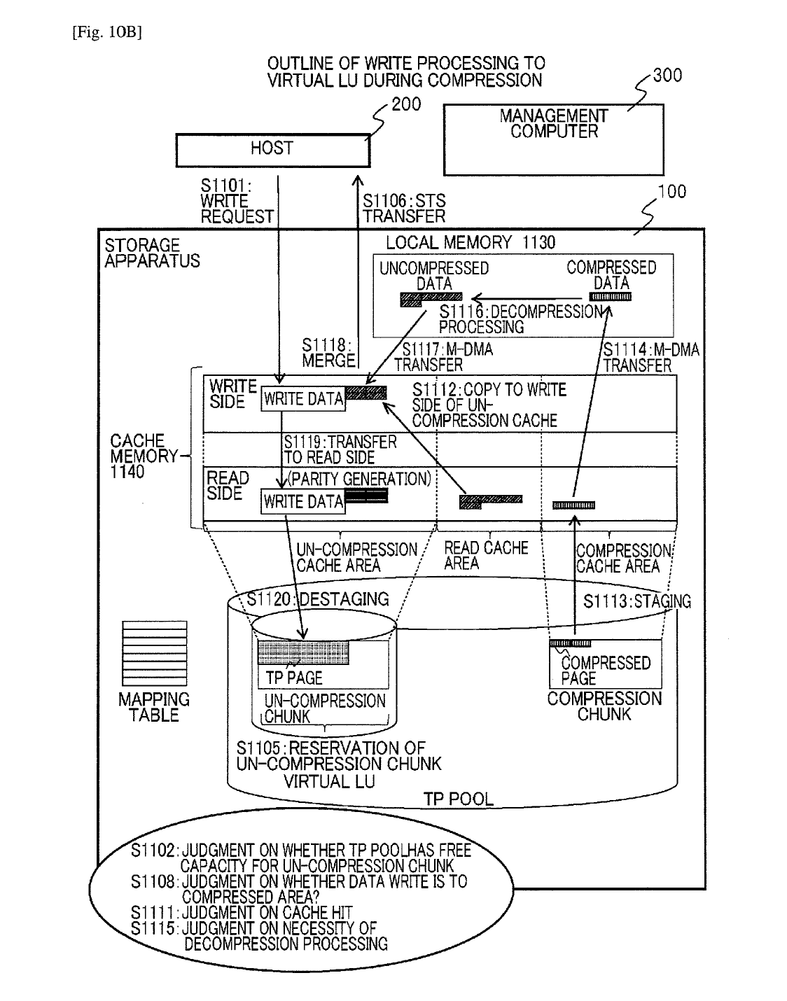

Next, explanation will be given of processing of writing data to a virtual LU during compression. As in the case with the read processing described above, the virtual LU allocated to the host 200 contains both a compression chunk and an un-compression chunk as illustrated in FIG. 3. FIG. 10A illustrates a flow example of the data write processing to a virtual LU during compression, and FIG. 10B illustrates an outline of the processing. The outline in FIG. 10B is based on the outline of the operations in the storage system 1 in FIG. 6, and illustrates how commands and data are sent and received in the storage system 1 when the processing flow in FIG. 10A is executed. This processing starts (S1101) when the data IO processing unit 1330 in the storage control unit 1100 in the storage apparatus 100 receives a data write request from the host 200. The data IO processing unit 1330 firstly judges whether or not the uncompression chunk in the TP chunk has free storage capacity (S1102), and further judges whether or not reservation of an un-compression chunk is possible (S1103) when judging that the necessary storage capacity is not available (S1102: No). When judging that the reservation of the un-compression chunk is not possible (S1103: No), the data IO processing unit 1330 notifies the host 200 of a write failure and terminates the processing (S1104, S1121). When judging that the reservation of the uncompression chunk is possible in S1103, the data IO processing unit 1330 reserves the un-compression chunk and advances the processing to status transmission in S1106 (S1105).

When judging that the un-compression chunk has a free storage capacity in S1102 (S1102: Yes), the data IO processing unit 1330 performs the status transmission to notify the host 200 that the data write processing is normally accepted (S1106), and transfers the write data to the cache memory 1140 (S1107). Note that, the status transmission may be performed at any other timing. Then, the data IO processing unit 1330 judges whether or not the data write request is made for the compressed storage area with reference to the LBA information in the received data write request and the status flag 1404 in the mapping table 1400 (S1108). When judging that the data write request is not made for the compressed storage area (S1108: No), the data IO processing unit 1330 transfers the write data to the read side of the cache memory 1140, destages the write data to the un-compression chunk of the write target, and then terminates the processing (S1109, S1110, S1121).

When judging that the data write request is made for the compressed storage area in S1108 (S1108: Yes), the data IO processing unit 1330 judges whether or not the decompressed data is present in the read cache of the cache memory 1140. When judging that the decompressed data is present (S1111: Yes), the data IO processing unit 1330 transfers the data in the read cache to the un-compression cache and advances the processing to S1118 (S1112).

When judging that the decompressed data is not present in S1111 (S1111: No), the data IO processing unit 1330 stages the compressed data in the compression chunk to the read side of the cache memory 1140 (S1113), and then transfers the compressed data to the local memory 1130 (S1114). In the local memory 1130, the data compression-decompression processing unit 1320 judges whether or not the staged data is compressed data (S1115), decompresses the data on the local memory 1130 (S1116) when judging that the data is compressed data (S1115: Yes), and then transfers the decompressed data to the write side of the cache memory 1140 (S1117). When judging that the data is not compressed data in S1115, the data compression-decompression processing unit 1320 skips the data decompression processing in S1116.

In S1118, the data IO processing unit 1330 merges the write data and any of the data decompressed in S1117, the decompressed data in the read cache, and the data judged as uncompressed in S1115. Then, the data IO processing unit 1330 transfers the merged data to the read side of the cache memory 1140 (S1119), destages the data to the un-compression chunk, and terminates the processing (S1120, S1121).

Through the above processing, in the case of writing data to a virtual LU provided to the host 200 and including a compression chunk, the decompressed data stored in the cache memory 1140 can be utilized, and therefore the staging and the decompression processing of the compressed data do not have to be always performed in the data write processing. Thus, the data IO performance of the storage apparatus 100 is improved.

Data Read/Write Processing on Normal LU during Compression

Next, description is given of data write/read processing on a normal LU during execution of the compression processing. Note that, since the normal LU is not deleted until all the data stored in the normal LU is compressed, the data read processing during the compression processing is exactly the same as the read processing from a normal LU formed of a RAID group, and thus explanation thereof is omitted herein.

Data Write Processing to Normal LU during Compression

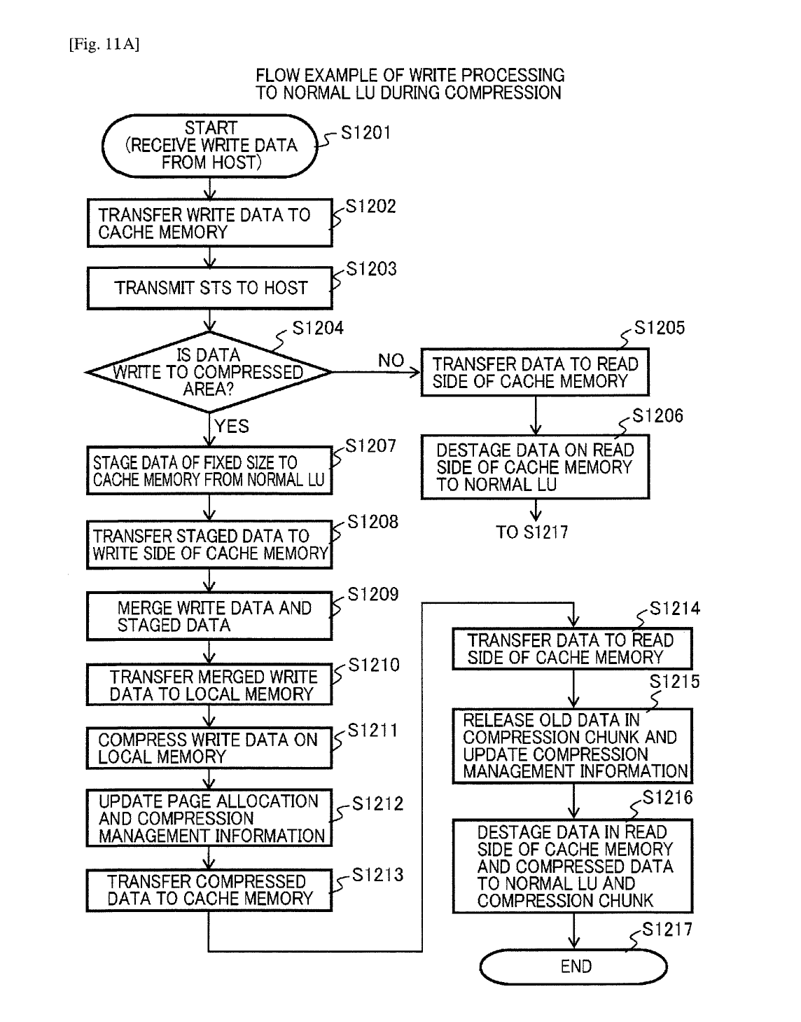

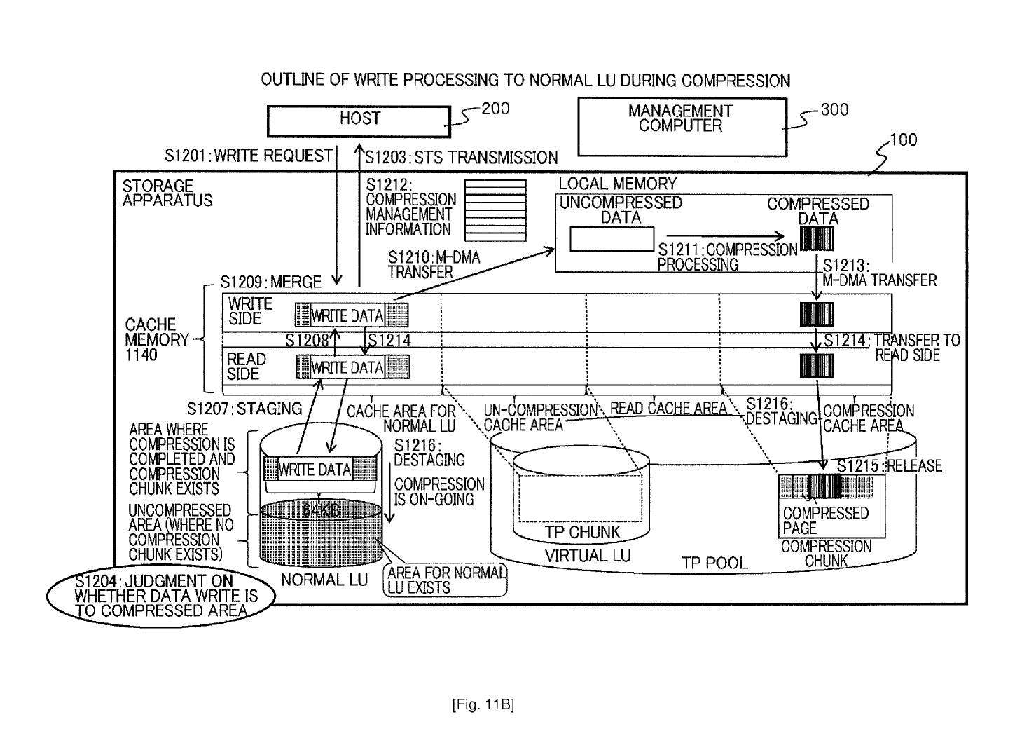

Firstly, explanation will be given of processing of writing data to a normal LU used by the host 200. In the case of a normal LU during compression, both data stored in the normal LU and data stored in a compression LU are updated according to a data write request received during the compression. In this way, even when a data read request is made for a normal LU during compression, the updated data can be read from the normal LU. FIG. 11A illustrates a flow example of the data write processing to a normal LU during compression, and FIG. 11B illustrates an outline of the processing. The outline in FIG. 11B is based on the outline of the operations in the storage system 1 in FIG. 6, and illustrates how commands and data are sent and received in the storage system 1 when the processing flow in FIG. 11A is executed. This processing starts (S1201) when the data IO processing unit 1330 in the storage control unit 1100 in the storage apparatus 100 receives a data write request from the host 200. The data IO processing unit 1330 firstly transfers the write data from the host 200 to the cache memory 1140 (S1202), and sends the host 200 a status signal notifying that the write request is normally accepted (S1203).

Then, the data IO processing unit 1330 judges whether or not the data write request is made for a compressed area (S1204). When judging that the request is not made for a compressed area (S1204: No), the data IO processing unit 1330 transfers the write data to the read side of the cache memory 1140 (S1205), destages the data to the uncompressed area in the normal LU and terminates the processing (S1206).

When judging that the write request is made for the compressed area in S1204 (S1204: Yes), the data IO processing unit 1330 stages data of a fixed size to the cache memory 1140 from a write target in the compressed area in the normal LU (S1207), and transfers the data to the write side of the cache memory 1140 (S1208). Thereafter, the data IO processing unit 1330 merges the write data and the staged data (S1209), and transfers the merged data as write data to the local memory 1130 (S1210). In the local memory 1130, the data compression-decompression processing unit 1320 compresses the write data (S1211). Then, the data IO processing unit 1330 updates the page allocation and the compression management information in the mapping table 1400 (S1212), and transfers the compressed data to the cache memory 1140 (S1213). The data IO processing unit 1330 transfers the compressed data to the read side of the cache memory 1140 (S1214), releases the old data in the compression chunk, and updates the compression management information in the mapping table 1400 (S1215). The releasing of the old data in the compression chunk is performed to enable data update in an area in the compression chunk protected as storing the old data during the compression, and is done, specifically, by overwriting the status flag 1404 in the mapping table 1400 to compressed. The data IO processing unit 1330 destages the data stored in the read side of the cache memory 1140 and the compressed data to the normal LU and the compression chunk, respectively, and then terminates the processing (S1216, S1217).

Through the foregoing processing, the data write processing can be performed on a compressed area and an uncompressed area in a normal LU provided to the host 200, and therefore the data read processing from the uncompressed area can be performed normally even during the compression.

Data Read/Write Processing on Compressed LU

Hereinafter, description will be given of data read/write processing on a compression LU.

Data Read Processing from Compressed LU

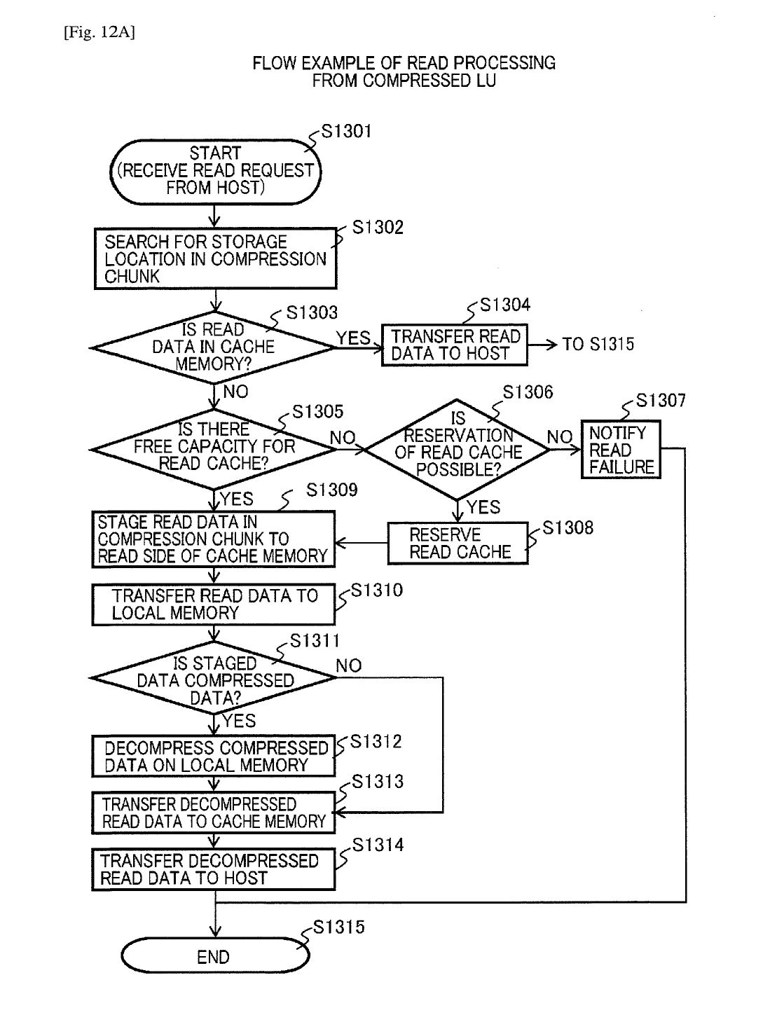

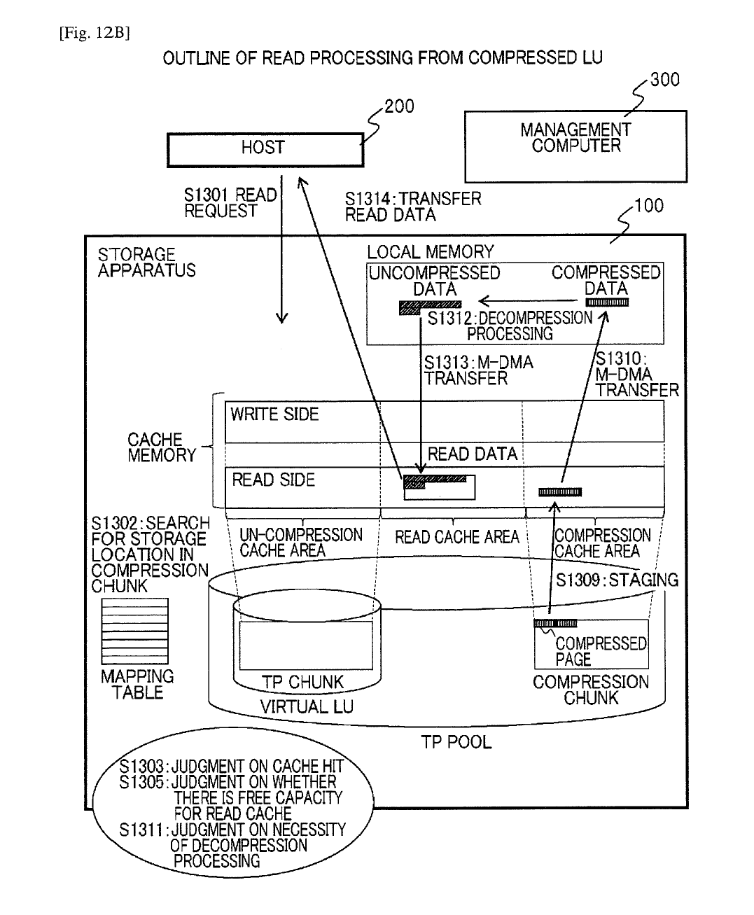

To be begin with, description will be given of processing of reading data from a compression LU used by the host 200. FIG. 12A illustrates a flow example of the processing of reading data from a compression LU, and FIG. 12B illustrates an outline of the processing. The outline in FIG. 12B is based on the outlines of the operations in the storage system 1 in FIG. 6, and illustrates how commands and data are sent and received in the storage system 1 when the processing flow in FIG. 12A is executed. This processing starts (S1301) when the data IO processing unit 1330 in the storage control unit 1100 in the storage apparatus 100 receives a data read request from the host 200. The data IO processing unit 1330 firstly refers to the compression management information recorded in the mapping table 1400 and thereby identifies the storage location of the read target data in the compression chunk (S1302). Then, the data IO processing unit 1330 judges whether or not the read data designated in the data read request is stored in the cache memory 1140 (S1303). When judging that the read data is stored in the cache memory 1140 (S1303: Yes), the data IO processing unit 1330 transfers the read data in the cache memory 1140 to the host 200 and terminates the processing (S1304, S1315).

When judging that the read data is not present in the cache memory 1140 (S1303: No), the data IO processing unit 1330 judges whether or not the cache memory 1140 has a free storage capacity usable as the read cache (S1305). When judging that the free storage capacity is not present (S1305: No), the data IO processing unit 1330 further judges whether or not reservation of a read cache is possible (S1306). When judging that the reservation of the read cache is not possible (S1306: No), the data IO processing unit 1330 notifies the host 200 of a read failure and terminates the processing (S1307, S1315). When judging that the reservation of the read cache is possible (S1306: Yes), the data IO processing unit 1330 reserves the read cache and advances the processing to S1309 (S1308). Note that, as in the case with the data read processing from a virtual LU during compression, in order to avoid a situation having a failure of the data read processing, the storage area for the read cache may be always set up in the cache memory 1140 instead of the step of judging whether or not the reservation of the read cache is possible in the cache memory 1140.

When judging that the cache memory 1140 has a free storage capacity for the read cache in S1305 (S1305: Yes), the data IO processing unit 1330 stages the read data in the compression chunk to the read side of the cache memory 1140 (S1309) and further transfers the read data to the local memory 1130 (S1310). Then, the data IO processing unit 1330 judges whether or not the staged read data is compressed data with reference to the mapping table 1400 (S1311). This judgment is set to data written to the compression chunk without being compressed in data write processing as a result of the judgment that the data produces no effects of compression, and to skip the decompression processing of the uncompressed data in the read processing. When it is judged that the staged read data is compressed (S1311: Yes), the data compression-decompression processing unit 1320 decompresses the read data on the local memory 1130 (S1312), and transfers the decompressed read data to the read side of the cache memory 1140 (S1313). Then, the data IO processing unit 1330 transfers the read data in the cache memory 1140 to the host 200 and terminates the processing (S1314, S1315). On the other hand, when judging that the staged data is not compressed in S1311 (S1311: No), the data IO processing unit 1330 skips S1312 and advances the processing to S1313.

Through the above processing, the already-read data stored in the cache memory 1140 can be utilized in reading the data from the compression LU provided to the host 200, and thereby the staging and the decompression processing of the compressed data do not have to be always performed in the data read processing. Thus, the data IO performance of the storage apparatus 100 is improved.

Data Write Processing to Compressed LU

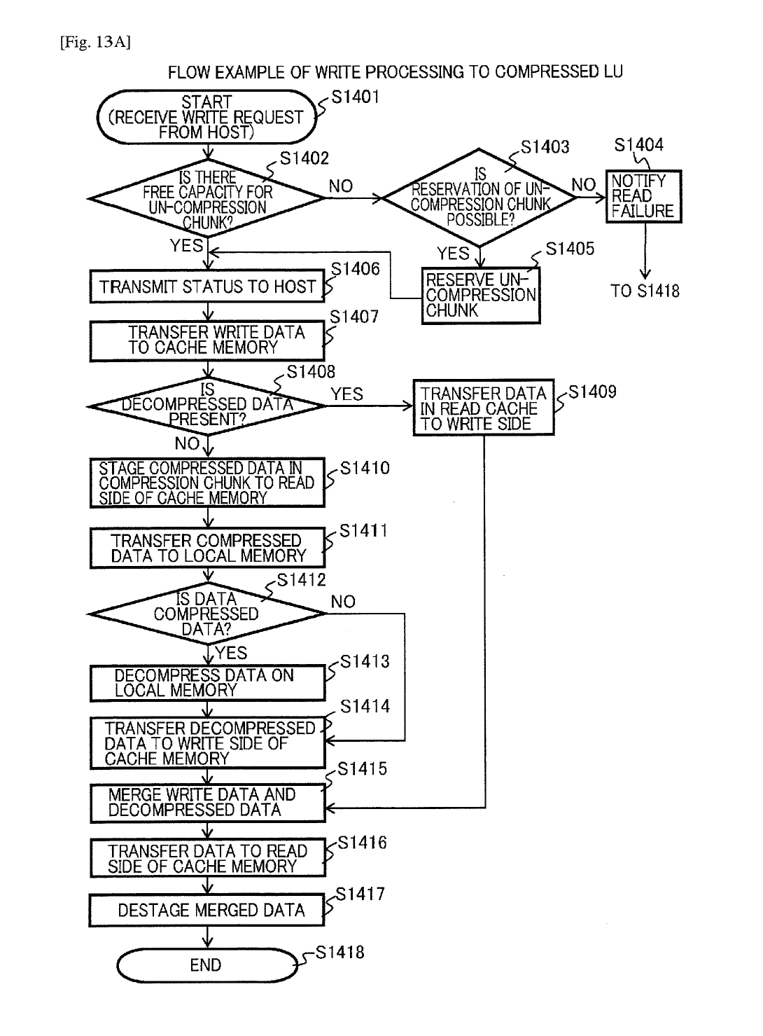

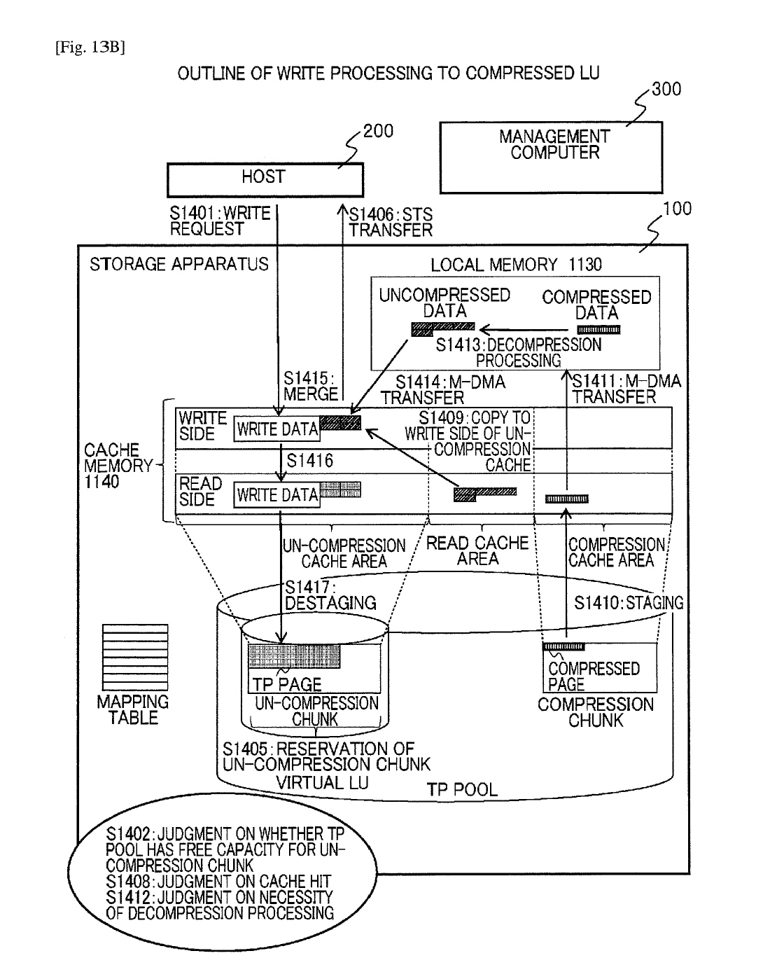

Next, description is given of processing of writing data to a compression LU used by the host 200. FIG. 13A illustrates a flow example of the processing of writing data to a compression LU, and FIG. 13B illustrates an outline of the processing. The outline in FIG. 13B is based on the outlines of the operations in the storage system 1 in FIG. 6, and illustrates how commands and data are sent and received in the storage system 1 when the processing flow in FIG. 13A is executed. The data IO processing unit 1330 in the storage control unit 1100 in the storage apparatus 100 starts this processing when receiving a data write request from the host 200 (S1401). The data IO processing unit 1330 firstly judges whether or not the un-compression chunk in the TP chunk has a free storage capacity (S1402), and further judges whether or not reservation of an uncompression chunk is possible (S1403) when judging that the free storage capacity is not present (S1402: No). When judging that the reservation of the un-compression chunk is not possible (S1103: No), the data IO processing unit 1330 notifies the host 200 of a write failure and terminates the processing (S1404, S1418). When judging that the reservation of the un-compression chunk is possible in S1403, the data IO processing unit 1330 reserves the un-compression chunk and advances the processing to status transmission in S1406 (S1405).

When judging that the un-compression chunk has free storage capacity in S1402 (S1402: Yes), the data IO processing unit 1330 performs the status transmission to notify the host 200 that the data write processing is normally accepted (S1406), and transfers the write data to the cache memory 1140 (S1407). Then, the data IO processing unit 1330 judges whether or not decompressed data corresponding to the write target data is present in the read cache of the cache memory 1140 (S1408). When judging that the decompressed data is present (S1408: Yes), the IO processing unit 1330 transfers the data in the read cache to the write side of the cache memory 1140 and advances the processing to S1415 (S1409).

When judging that the decompressed data is not present in the read cache in S1408 (S1408: No), the data IO processing unit 1330 stages the compressed data in the compression chunk to the read side of the cache memory 1140 (S1410), and then transfers the data to the local memory 1130 (S1411). In the local memory 1130, the data compression-decompression processing unit 1320 judges whether or not the staged data is the compressed data (S1412), decompresses the data on the local memory 1130 (S1413) when judging that the data is the compressed data (S1412: Yes), and then transfers the decompressed data to the write side of the cache memory 1140 (S1414). When judging that the data is not the compressed data in S1412 (S1412: No), the data compression-decompression processing unit 1320 skips the data decompression processing in S1413.

In S1415, the data IO processing unit 1330 merges the write data with any of the data decompressed in S1413, the decompressed data in the read cache, and the data judged as uncompressed in S1412. Then, the data IO processing unit 1330 transfers the merged data to the read side of the cache memory 1140 (S1416), destages the data to the un-compression chunk, and terminates the processing (S1417, S1418). The data stored in the un-compression chunk is compressed in background compression processing as a post process.

Through the above processing, the decompressed data stored in the cache memory 1140 can be utilized in writing the data to a compression LU provided to the host 200, and therefore the staging and the decompression processing of the compressed data do not have to be always performed in the data write processing. Thus, the data IO performance of the storage apparatus 100 is improved.

Data Compression Processing in Background

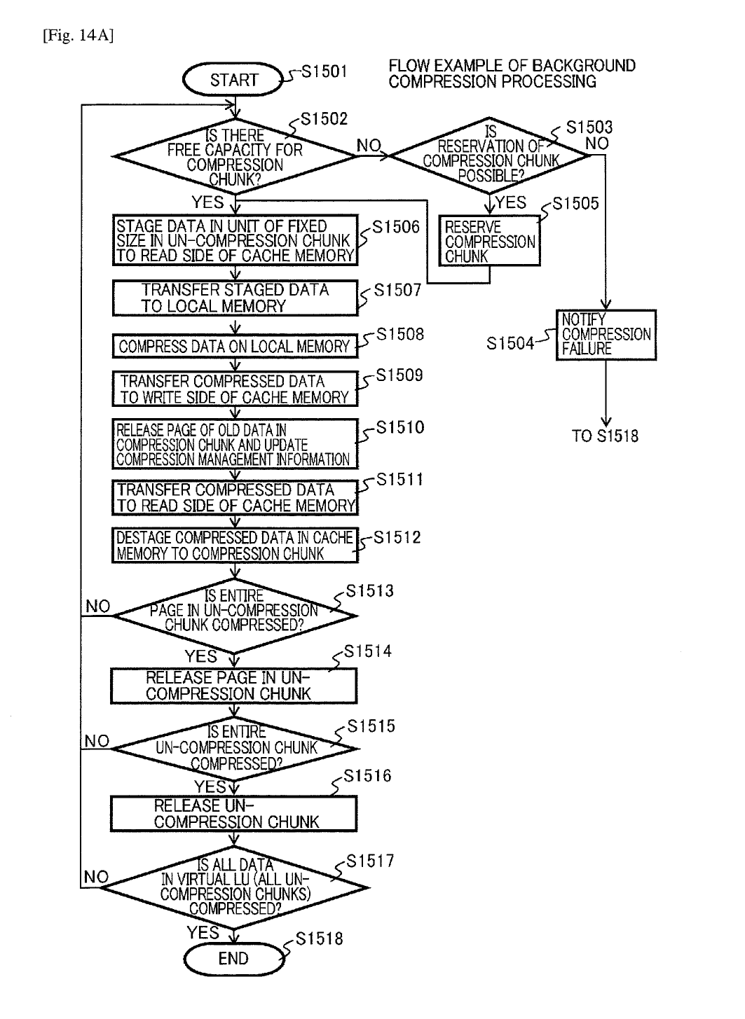

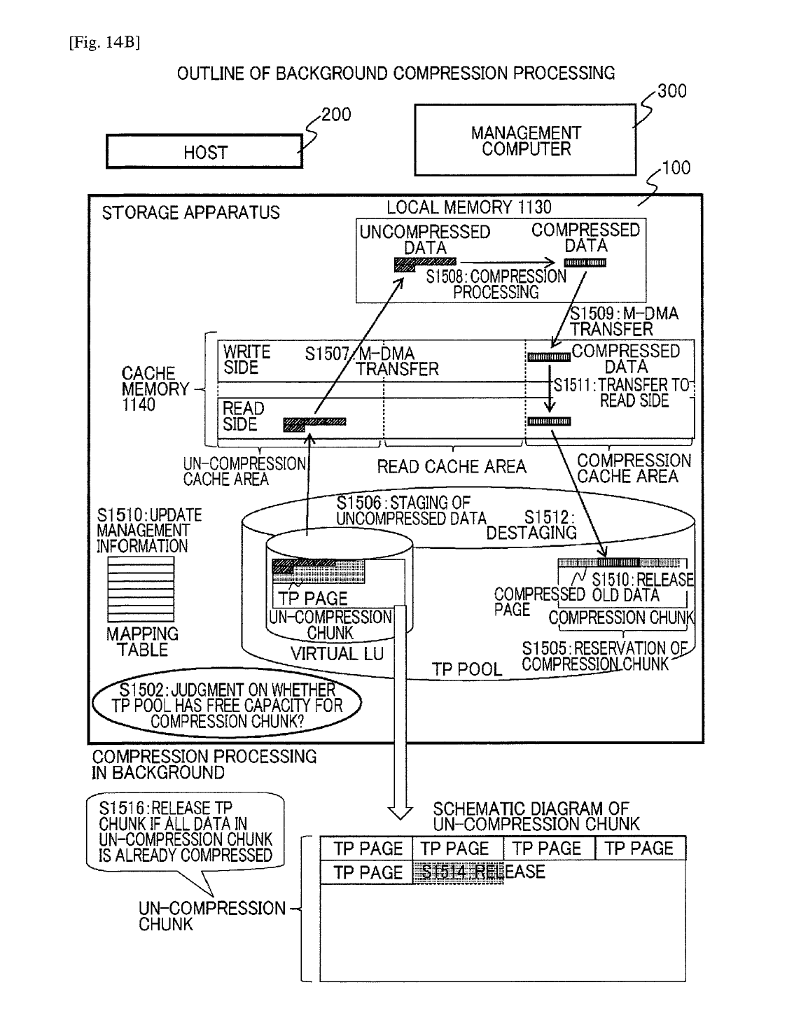

Description is provided below of data compression processing in the background. This data compression processing in the background is performed in order to efficiently utilize the storage apparatus 100 by increasing the available storage capacity of the storage apparatus 100, when the uncompressed data amount in the uncompression chunks exceeds a predetermined storage capacity, when the operation time of the storage system 1 reaches a predetermined period, or when any similar trigger event occurs. FIG. 14A illustrates a flow example of the data compression processing in the background, and FIG. 14B illustrates an outline of the processing. The outline in FIG. 14B is based on the outlines of the operations in the storage system 1 in FIG. 6, and illustrates how commands and data are sent and received in the storage system 1 when the processing flow in FIG. 14A is executed. Upon occurrence of any of the above-exemplary trigger events for execution of the background compression processing (S1501), the data IO processing unit 1330 judges whether or not the TP pool has free storage capacity usable as a compression chunk (S1502), and further judges whether or not reservation of a compression chunk is possible when judging that free storage capacity is not present (S1502: No, S1503). Then, when judging that the reservation of the compression chunk is not possible (S1503: No), the data IO processing unit 1330 notifies the management computer 300 of a failure of the compression processing and terminates the processing (S1504, S1518). When judging that the reservation of the compression chunk is possible (S1503: Yes), the data IO processing unit 1330 reserves the compression chunk and advances the processing to S1506 (S1505).

When judging that the free storage capacity for the compression chunk is present in S1502 (S1502: Yes), the LU compression processing unit 1310 stages compression target data in a unit of fixed size to the read side of the cache memory 1140 from the TP chunk that is the un-compression chunk (S1506). The LU compression processing unit 1310 transfers the staged data to the local memory 1130 (S1507), performs the data compression processing on the local memory 1130 by using predetermined data compression algorithm (S1508). Thereafter, the LU compression processing unit 1310 transfers the compressed data to the write side of the cache memory 1140 (S1509), releases the page which is so far protected because the old data in the compression chunk is stored therein, and updates the page allocation and the compression management information associated with the LBA information in the mapping table 1400 (S1510). After that, the LU compression processing unit 1310 transfers the compressed data to the read side of the cache memory 1140 (S1511), and destages the compressed data from the read side of the cache memory 1140 to the compression chunk (S1512). In this way, the uncompressed data of a fixed size is compressed.

Next, the LU compression processing unit 1310 judges whether or not all the data in the page of the un-compression chunk is compressed (S1513), releases the page in a unit size (for example, 32 MB) in the un-compression chunk (S1514) when judging that all the data is compressed (S1513: Yes), and then judges whether or not all the pages in the un-compression chunk are compressed (S1515). When judging that the un-compression chunk includes an uncompressed page (S1515: No), the LU compression processing unit 1310 advances the processing to S1502. When judging that all the pages in the un-compression chunk are compressed in S1515 (S1515: Yes), the LU compression processing unit 1310 releases the un-compression chunk (S1516), and judges whether or not all the un-compression chunks in the virtual LU are compressed (S1517). When judging that all the un-compression chunks in the designated virtual LU are compressed (S1517: Yes), the LU compression processing unit 1310 terminates the present processing (S1518). When judging that the designated virtual LU includes an un-compression chunk in S1517 (S1517: No), the LU compression processing unit 1310 advances the processing to S1502.

Through the foregoing processing, compression processing of virtual LUs provided to the host 200 is executed in the background of the normal operations on the virtual LUs of the storage apparatus 100, which enables efficient utilization of the storage capacity of the storage apparatus 100.

Thus, according to the present invention, provided are a storage apparatus and a method of controlling a storage apparatus which enable more efficient utilization of the storage resources of the storage apparatus while appropriately maintaining the performance of the storage apparatus, as has been heretofore described in detail based on the embodiments of the present invention.

It should be noted that although the present invention has been described based on the embodiments thereof with reference to the accompanying drawings, the present invention is not limited to these embodiments. In addition, the scope of the present invention includes any modified examples, equivalents and the like that would be made without departing from the spirit and scope of the present invention.

1. A storage apparatus configured to provide a data storage area to an external apparatus, comprising:
a storage drive configured to provide a physical storage area for the data storage area; and
a storage control unit configured to manage the data storage area as an un-compression storage area that is a logical storage area for storing data in the external apparatus in an uncompressed form and as a compression storage area that is a logical storage area for storing data in the external apparatus in a compressed form, and to control each of data write processing and data read processing on the storage drive according to a data input-output request from the external apparatus,
wherein
the compression storage area and the un-compression storage area each include a set of unit physical storage areas formed by dividing the physical storage area,
the storage control unit includes an un-compression cache area that is a temporary memory area for storing uncompressed data, a compression cache area that is a temporary memory area for storing compressed data, and a read cache area that is a temporary memory area for storing data read from the compression storage area,
when reading data from the compression storage area in response to a data read request from the external apparatus, the storage control unit decompresses the read data and stores the decompressed data to the read cache area,
in a case where the storage control unit receives a data read request from the external apparatus and where read target data of the data read request is stored in the compression storage area, the storage control unit judges whether or not the read target data is stored in the read cache area,
when judging that the data is stored in the read cache area, the storage control unit transfers the data stored in the read cache area to the external apparatus, and
when judging that the data is not stored in the read cache area, the storage control unit reads the read target data from the compression storage area, decompresses the data, and then transfers the decompressed data to the external apparatus.

2. The storage apparatus according to claim 1, wherein
the unit physical storage areas forming the compression storage area are each set to have a smaller storage capacity than the unit physical storage areas forming the un-compression storage area.

3. The storage apparatus according to claim 1, wherein
a unit size of data stored in the compression cache area is set to be smaller than a unit size of data stored in the un-compression cache area.

4. The storage apparatus according to claim 1, wherein
when judging that a predetermined condition is satisfied, the storage control unit performs processing in background of reading data stored in the un-compression storage area, compressing the data, and storing the compressed data into the compression storage area.

5. The storage apparatus according to claim 4, wherein
a part of the physical storage area is fixedly allocated to the uncompression storage area, and
in a case where the storage control unit receives the data write request from the external apparatus during execution of data movement from the un-compression storage area to the compression storage area, the storage control unit performs processing of:
judging whether or not the data write request is made for data stored in the compression storage area;
when judging that the data write request is made for the data stored in the compression storage area, updating the data stored in the compression storage area, and data stored in the un-compression storage area corresponding to the data stored in the compression storage area.

6. The storage apparatus according to claim 1, wherein
when reading data from the compression storage area, the storage control unit judges whether or not the read target data is compressed data, and skips decompression of the read target data when judging that the read target data is not compressed data.

7. A method of controlling a storage apparatus configured to provide a data storage area to an external apparatus, the storage apparatus including
a storage drive configured to provide a physical storage area for the data storage area; and
a storage control unit configured to manage the data storage area as an un-compression storage area that is a logical storage area for storing data in the external apparatus in an un-compressed form and as a compression storage area that is a logical storage area for storing data in the external apparatus in a compressed form, and to control each of data write processing and data read processing on the storage drive according to a data input-output request from the external apparatus, the compression storage area and the un-compression storage area each including a set of unit physical storage areas formed by dividing the physical storage area, the storage control unit including an uncompression cache area that is a temporary memory area for storing uncompressed data, a compression cache area that is a temporary memory area for storing compressed data, and a read cache area that is a temporary memory area for storing data read from the compression storage area, the method comprising:
when reading data from the compression storage area in response to a data read request from the external apparatus, decompressing, by the storage control unit, the read data and store the decompressed data to the read cache area;
in a case where the storage control unit receives a data read request from the external apparatus and where read target data of the data read request is stored in the compression storage area, judging, by the storage control unit, whether or not the read target data is stored in the read cache area;
when judging that the data is stored in the read cache area, transferring, by the storage control unit, the data stored in the read cache area to the external apparatus; and
when judging that the data is not stored in the read cache area, by the storage control unit, reading the read target data from the compression storage area, decompressing the data, and then transferring the decompressed data to the external apparatus.

8. The method of controlling a storage apparatus according to claim 7, wherein
the unit physical storage areas forming the compression storage area are each set to have a smaller storage capacity than the unit physical storage areas forming the un-compression storage area.

9. The method of controlling a storage apparatus according to claim 7, wherein
a unit size of data stored in the compression cache area is set to be smaller than a unit size of data stored in the un-compression cache area.

10. The method of controlling a storage apparatus according to claim 7, wherein
When judging that a predetermined condition is satisfied, the storage control unit performs processing in background of reading data stored in the un-compression storage area, compressing the data, and storing the compressed data into the compression storage area.

11. The method of controlling a storage apparatus according to claim 10, wherein
a part of the physical storage area is fixedly allocated to the uncompression storage area,
in a case where the storage control unit receives the data write request from the external apparatus during execution of data movement from the un-compression storage area to the compression storage area, the storage control unit performs processing of:
judging whether or not the data write request is made for data stored in the compression storage area;
when judging that the data write request is made for data stored in the compression storage area, updating the data stored in the compression storage area and data stored in the un-compression storage area corresponding to the data stored in the compression storage area.

12. The method of controlling a storage apparatus according to claim 7, wherein
when reading data from the compression storage area, the storage control unit judges whether or not the read target data is compressed data, and skips decompression of the read target data when judging that the read target data is not compressed data.
